(19) United States
(12) Patent Application Publication
(10) Pub. No.: US 2026/0242258 A1
(43) Pub. Date: Aug. 20, 2026

(54) WATER TREATMENT APPARATUS AND CONTROL METHOD OF WATER TREATMENT APPARATUS

(71) Applicant: SAMSUNG ELECTRONICS CO., LTD., Suwon-si (KR)

(72) Inventors: Sungpil HONG, Suwon-si (KR); Sungwon KIM, Suwon-si (KR); Jeeyeon KIM, Suwon-si (KR); Heejin PARK, Suwon-si (KR); Changhoon OH, Suwon-si (KR); Changbae LIM, Suwon-si (KR); Wonji JUNG, Suwon-si (KR)

(73) Assignee: SAMSUNG ELECTRONICS CO., LTD., Suwon-si (KR)

(21) Appl. No.: 19/645,964

(22) Filed: Apr. 13, 2026

Related U.S. Application Data
(63) Continuation of application No. PCT/KR2024/012208, filed on Aug. 16, 2024.

(30) Foreign Application Priority Data
Oct. 13, 2023 (KR) 10-2023-0137182

(51) Int. Cl. C02F 1/469; B01D 61/42; B01D 61/46; B01D 61/54; B01J 39/07; B01J 39/16; B01J 41/07; B01J 41/09; B01J 47/12; C02F 1/00

(52) U.S. Cl. CPC C02F 1/4691; B01D 61/428; B01D 61/461; B01D 61/54; B01J 39/07; B01J 39/16; B01J 41/07; B01J 41/09; B01J 47/12; C02F 1/008; C02F 1/4695; B01D 2313/18; B01D 2313/50; B01D 2313/60; C02F 2201/005; C02F 2201/46115; C02F 2201/46135; C02F 2201/46145; C02F 2301/046

(57) ABSTRACT

A water treatment apparatus includes: a first channel including a first current collector and a cation exchange membrane; a second channel including a second current collector and an anion exchange membrane; a third channel between the first channel and the second channel and including an ion exchange resin layer; a storage tank configured to store an electrolyte aqueous solution supply for any of the first and second channels; at least one circulation flow path valve on a circulation flow path configured to connect the first channel, the second channel, and the storage tank; and a controller including a processor and configured to control the at least one circulation flow path valve to allow the electrolyte aqueous solution to circulate through the first channel, the second channel, and the storage tank, based on at least one of a deionization operation or a regeneration operation being performed in a desalination operation.

### CROSS-REFERENCE TO RELATED APPLICATIONS

This application is a continuation of International Application No. PCT/KR2024/012208, filed on Aug. 16, 2024, which is based on and claims priority to Korean Patent Application No. 10-2023-0137182, filed on Oct. 13, 2023, in the Korean Intellectual Property Office, the disclosures of which are incorporated by reference herein in their entireties.

### BACKGROUND

### 1. Field

The disclosure relates to a water treatment apparatus using a capacitive deionization technology, and a method for controlling the water treatment apparatus.

### 2. Description of Related Art

Capacitive deionization (CDI), an example of a water treatment process, generally removes ions by applying a voltage between two electrodes, causing ions in water flowing between the electrodes to be adsorbed on the electrodes, and reversing the electrode voltage desorbs the adsorbed ions from the electrodes.

Although the CDI process is energy-efficient and environmentally friendly, its deionization efficiency varies depending on the types of ions dissolved in water.

Another example of a water treatment process is electrodeionization (EDI), which combines electrochemical and ion exchange processes. EDI removes ions through an electrochemical reaction using ion-selective membranes, ion exchange resins, electrodes, and the like.

The EDI process has high performance and is mainly used for producing pure and ultrapure water. However, EDI inevitably causes a local pH increase due to the water dissociation phenomenon occurring at interfaces of the ion exchange resin, which in turn promotes scale formation by divalent ions.

### SUMMARY

Provided are a water treatment apparatus which may have increased deionization efficiency by supplying a deionization module with an electrolyte aqueous solution, and a method for controlling the water treatment apparatus. According to an aspect of the disclosure, there is provided a water treatment apparatus including: a first channel including a first current collector and a cation exchange membrane; a second channel including a second current collector and an anion exchange membrane; a third channel arranged between the first channel and the second channel and including an ion exchange resin layer; a storage tank configured to store an electrolyte aqueous solution supplied to at least one of the first channel or the second channel; at least one circulation flow path valve provided on a circulation flow path configured to connect the first channel, the second channel, and the storage tank; and a controller including a processor, the controller being configured to control the at least one circulation flow path valve to allow the electrolyte aqueous solution to circulate through the first channel, the second channel, and the storage tank, based on at least one of a deionization operation being performed in a desalination operation or a regeneration operation being performed in the desalination operation.

The at least one circulation flow path valve may include: a first circulation flow path valve configured to adjust first a flow of the electrolyte aqueous solution supplied to the first channel; and a second circulation flow path valve configured to adjust a second flow of the electrolyte aqueous solution supplied to the second channel, and the controller may be further configured to control the first circulation flow path valve and the second circulation flow path valve to allow the electrolyte aqueous solution to be supplied to at least one of the first channel or the second channel.

The at least one circulation flow path valve may further include a third circulation flow path valve configured to adjust a third flow of the electrolyte aqueous solution supplied to the storage tank, and the controller may be further configured to control the third circulation flow path valve to allow the electrolyte aqueous solution to be supplied to the storage tank from at least one of the first channel or the second channel.

The water treatment apparatus may further include a concentration sensor configured to detect a concentration of the electrolyte aqueous solution in the first channel, and the controller may be further configured to turn on the first circulation flow path valve, the second circulation flow path valve, and the third circulation flow path valve, based on the concentration detected by the concentration sensor being less than or equal to a preset minimum concentration.

The controller may be further configured to turn off the first circulation flow path valve, the second circulation flow path valve, and the third circulation flow path valve, based on the concentration detected by the concentration sensor being greater than or equal to a preset maximum concentration.

The ion exchange resin layer may be provided only in a portion of the third channel.

The ion exchange resin layer may include at least one of a weak base anion exchange resin or a weak acid cation exchange resin.

The ion exchange resin layer may include the weak base anion exchange resin, and the weak base anion exchange resin may include at least one of trimethylamine (TMA) or dimethylethanolamine (DMEA) as a functional group.

The ion exchange resin layer may include the weak acid cation exchange resin, and the weak acid cation exchange resin may include a carboxyl group (—COOH) as a functional group.

The water treatment apparatus may further include a power supply device configured to apply a voltage to the first current collector and the second current collector during the deionization operation and the regeneration operation, and the controller may be further configured to: in the deionization operation, apply a negative voltage between the first current collector and the second current collector to cause cations dissolved in water in the third channel to be adsorbed on the ion exchange resin layer or move to the first channel, and in the regeneration operation, apply a positive voltage between the first current collector and the second current collector to any of cause the cations adsorbed on the ion exchange resin layer to be desorbed and dissolved in the water in the third channel and cause the cations in the first channel to move to the water in the third channel.

The controller may be further configured to control the power supply device to allow a magnitude of the voltage applied to the first current collector and the second current collector to be less than a water dissociation generation voltage.

The controller may be further configured to control the at least one circulation flow path valve to allow the electrolyte aqueous solution to circulate through the first channel, the second channel, and the storage tank, based on a post-treatment operation being performed during the desalination operation.

According to an aspect of the disclosure, there is provided a method for controlling a water treatment apparatus including a first channel, a second channel, a third channel between the first channel and the second channel and including an ion exchange resin layer, and a storage tank configured to store an electrolyte aqueous solution supplied to at least one of the first channel or the second channel, the method including: supplying the electrolyte aqueous solution to the first channel by controlling a first circulation flow path valve configured to adjust a first flow of the electrolyte aqueous solution supplied to the first channel, based on any of a deionization operation and a regeneration operation being performed in a desalination operation; and supplying the electrolyte aqueous solution to the second channel by controlling a second circulation flow path valve configured to adjust a second flow of the electrolyte aqueous solution supplied to the second channel.

The method may further include supplying the electrolyte aqueous solution to the storage tank from any of the first channel and the second channel by controlling a third circulation flow path valve configured to adjust a third flow of the electrolyte aqueous solution supplied to the storage tank.

The water treatment apparatus may further include a concentration sensor configured to detect a concentration of the electrolyte aqueous solution in the first channel, and the method may further include turning on the first circulation flow path valve, the second circulation flow path valve, and the third circulation flow path valve, based on the concentration detected by the concentration sensor being less than or equal to a preset minimum concentration.

The method may further include turning off the first circulation flow path valve, the second circulation flow path valve, and the third circulation flow path valve, based on the concentration detected by the concentration sensor being greater than or equal to a preset maximum concentration.

The ion exchange resin layer may be provided only in a portion of the third channel.

The ion exchange resin layer may include at least one of a weak base anion exchange resin or a weak acid cation exchange resin.

The ion exchange resin layer may include the weak base anion exchange resin, and the weak base anion exchange resin comprises trimethylamine (TMA) or dimethylethanolamine (DMEA) as a functional group.

The ion exchange resin layer may include the weak acid cation exchange resin, and the weak acid cation exchange resin comprises a carboxyl group (—COOH) as a functional group.

According to an aspect of the disclosure, by supplying a deionization module with an electrolyte aqueous solution, a deionization performance of the deionization module may increase in a deionization operation, addition of separate chemicals for regeneration of an ion exchange resin layer is not required in a regeneration operation, and scale generation may be lower compared to a water treatment device equipped with only one of the capacitive deionization (CDI) module or electrodeionization (EDI) module.

The effects that may achieved by the disclosure are not limited to the above-mentioned effects, and other effects not mentioned will be clearly understood by one of ordinary skill in the technical art to which the disclosure belongs from the following description.

### BRIEF DESCRIPTION OF DRAWINGS

The above and other aspects, features, and advantages of specific embodiments of the present disclosure will be more apparent from the following description with reference to the accompanying drawings, in which:

FIG. 1 is a conceptual diagram illustrating an example of a water treatment apparatus according to one or more embodiments;

FIG. 2 is a conceptual diagram illustrating an example of a water treatment apparatus including an electrolyte solution tank according to one or more embodiments;

FIG. 3 is a conceptual diagram illustrating movement of ions occurring at both electrodes during a deionization operation of a water treatment apparatus according to one or more embodiments;

FIG. 4 is a conceptual diagram illustrating movement of ions occurring at both electrodes during a regeneration operation of a water treatment apparatus according to one or more embodiments;

FIG. 5 is a conceptual diagram illustrating movement of ions and chemical reaction occurring at an interface of a cation exchange resin according to one or more embodiments;

FIG. 6 is a conceptual diagram illustrating movement of ions and chemical reaction occurring at an interface of an anion exchange resin according to one or more embodiments;

FIG. 7 is a control block diagram of a water treatment apparatus according to one or more embodiments;

FIG. 8 is a diagram illustrating a process of removing ions from water during a deionization operation of a water treatment apparatus according to one or more embodiments;

FIG. 9 is a diagram illustrating that deionization efficiency is increased by supplying an electrolyte aqueous solution to a deionization module according to one or more embodiments;

FIG. 10 is a diagram illustrating a process of regenerating both electrodes and an ion exchange resin layer during a regeneration operation of a water treatment apparatus according to one or more embodiments;

FIG. 11 is a diagram illustrating pH change during a regeneration operation in a capacitive deionization (CDI) module according to one or more embodiments;

FIG. 12 is a diagram illustrating pH change during a regeneration operation in an electrodeionization (EDI) module according to one or more embodiments;

FIG. 13 is a diagram illustrating pH change during a regeneration operation in a water treatment apparatus according to one or more embodiments in comparison with FIG. 12 and FIG. 13;

FIG. 14 is a conceptual diagram illustrating an example of a water treatment apparatus including an electrolyte solution tank according to one or more embodiments;

FIG. 15 is a schematic diagram illustrating operating sequences of a water treatment apparatus according to one or more embodiments; and

FIG. 16 is a flowchart illustrating a method for controlling a water treatment apparatus according to one or more embodiments.

### DETAILED DESCRIPTION

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases. For example, the expression, “at least one of A, B, or C,” should be understood as including only A, only B, only C, both A and B, both A and C, both B and C, or all of A, B, and C.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled,” or “connected” to another element (e.g., a second element), the first element may be connected to the second element, directly (e.g., wired), wirelessly, or through a third element.

In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

When an element is “on” another element, this includes not only when the element is in contact with the other element, but also when there is another element between the two elements.

A water treatment apparatus according to various embodiments may purify contaminated water to a clean state. The water treatment apparatus is used in wastewater treatment facilities, industrial processes, and water supply systems used in homes and offices, playing an important role in environmental protection and human health. Clean water purified by the water treatment apparatus may be returned to nature or used for cleaning purposes, used as drinking water, or reused in industrial processes or the like.

According to various embodiments, the water treatment apparatus may include not only household water treatment apparatuses such as a water purifier or a water softener but also industrial water treatment apparatuses.

According to various embodiments, the water treatment apparatus may be provided inside household electronic appliances, such as a refrigerator, a washing machine, or a dishwasher.

For example, the water treatment apparatus may be provided inside a washing machine to remove impurities contained in water supplied into a washing machine drum or discharged from the drum.

Through the above, not only may washing performance be improved, but also contaminated water after washing may be reused to create an efficient washing cycle.

It will be apparent to those skilled in the art that the operation details of the water treatment apparatus provided in the washing machine are equally applicable to the water treatment apparatus provided in other household electronic appliances such as a refrigerator and a dishwasher. The water treatment apparatus may purify contaminated water using a variety of methods, such as biological treatment methods, chemical treatment methods, and physical treatment methods.

A water treatment apparatus according to one or more embodiments may purify contaminated water via a capacitive deionization (CDI) method and electrodeionization (EDI) method.

The CDI method refers to a method of removing ions from contaminated water using a principle that ions are adsorbed to and desorbed from the surfaces of electrodes by an electrical force generated between the electrodes. Throughout this specification, removing ions from contaminated water may include removing ionic substances of contaminated water.

The water treatment apparatus may include various components, such as a plurality of pipes in which water flows, a plurality of valves for controlling the flow of water, and a CDI module for purifying water by a CDI method.

The CDI module may include a housing, and electrodes and ion exchange membranes provided in the housing. By applying a voltage to the electrodes, ions contained in water flowing into the housing may be adsorbed on the electrodes or desorbed from the electrodes.

According to various embodiments, the water treatment apparatus may further include various components, such as a pre-treatment filter for pre-treatment of raw water to be supplied to the CDI module and/or a post-treatment filter for filtering water purified by the CDI module again.

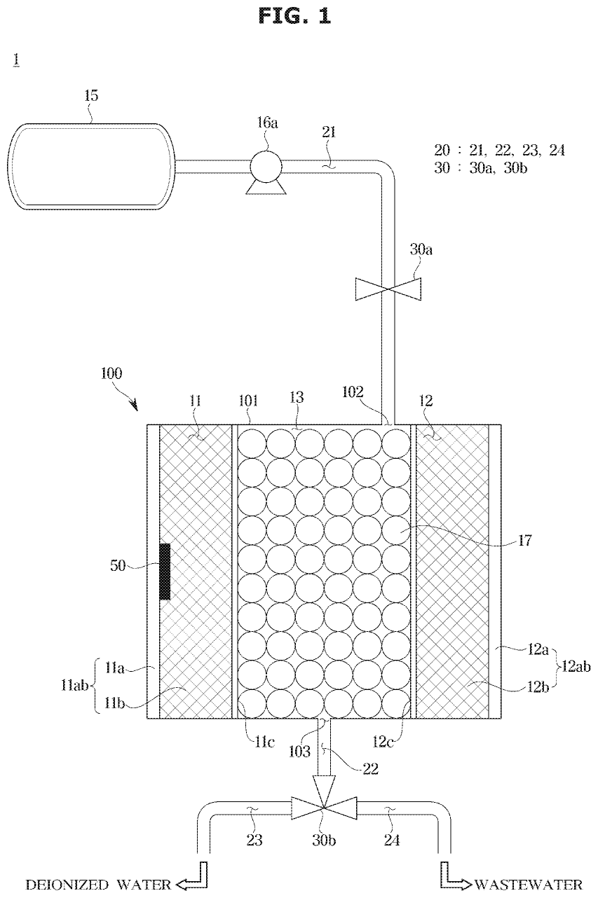

FIG. 1 is a conceptual diagram illustrating an example of a water treatment apparatus according to one or more embodiments.

Referring to FIG. 1, a water treatment apparatus 1 according to one or more embodiments may include a deionization module 100, at least one flow path 20 formed by pipes, and at least one valve unit 30 adjusting water flow in the at least one flow path 20.

A first electrode 11ab and a second electrode 12ab may be disposed opposite to each other, and the first electrode 11ab and the second electrode 12ab disposed opposite to each other may form a capacitor.

The first electrode 11ab may include a first current collector 11a and a first porous electrode 11b.

As further described below, the first electrode may be a negative electrode (cathode) during a deionization operation of the water treatment apparatus 1, and may be a positive electrode (anode) during a regeneration operation or descaling operation.

In one or more embodiments, the first current collector 11a may include a pole plate electrically connected to the second porous electrode 11b. The pole plate may include a metallic plate and/or a non-metallic plate.

A material of the first current collector 11a may be a conductor. For example, the material of the first current collector 11a may be graphite, without being limited thereto.

The first porous electrode 11b may include a solid electrode including an empty space (or a void space). The first porous electrode 11b may be made of a material that is susceptible to adsorbing ions. For example, the first porous electrode 11b may be a carbon porous electrode, but the type of the first porous electrode 11b is not limited thereto.

The second electrode 12ab may include a second current collector 12a and a second porous electrode 12b.

As further described below, the second electrode may be a positive electrode (anode) during the deionization operation of the water treatment apparatus 1, and may be a negative electrode (cathode) during the regeneration operation or descaling operation.

In one or more embodiments, the second current collector 12a may include a pole plate electrically connected to the second porous electrode 12b. The pole plate may include a metallic plate and/or a non-metallic plate.

A material of the second current collector 12a may also be the same as that of the first current collector 11a.

However, for economic reasons, in one or more embodiments, the materials of the first current collector 11a and the second current collector 12a may be different from each other. For example, the material of the first current collector 11a may be selected from the group consisting of a transition metal, transition metal oxide, transition metal alloy, aluminum, aluminum oxide, aluminum alloy, graphene, dimensionally stable anode (DSA), and boron doped diamond (BDD) electrode, and the material of the second current collector 12a may be graphite.

The second porous electrode 12b may include a solid electrode including an empty space. The second porous electrode 12b may be made of a material susceptible to adsorbing ions. For example, the second porous electrode 12b may be a carbon porous electrode, but the type of second porous electrode 12b is not limited thereto.

The deionization module 100 may include a housing 101 having a third channel inlet 102 into which water flows and an outlet 103 through which deionized water from which hardness components have been removed from the introduced water or wastewater in which hardness components are dissolved in the introduced water is discharged. In one or more embodiments, at least a portion of the surfaces of the housing 101 may be configured as the current collectors 11a and 12a. However, at least a portion of the surfaces of the housing 101 may also be configured as pads for supporting the current collectors 11a and 12a.

The deionization module 100 may include a first channel 11 formed by the first current collector 11a and a cation exchange membrane 11c, a second channel 12 formed by the second current collector 12a and an anion exchange membrane 12c, and a third channel 13 formed by the cation exchange membrane 11c and the anion exchange membrane 12c.

The first channel 11 may include a space between the first current collector 11a and the cation exchange membrane 11c. The second channel 12 may include a space between the second current collector 12a and the anion exchange membrane 12c. The third channel 13 may include a space between the cation exchange membrane 11c and the anion exchange membrane 12c.

The first channel 11, the second channel 12, and the third channel 13 may be replaced with terms, such as a compartment, space, room, or chamber in that the first channel 11, the second channel 12, and the third channel 13 may be distinguished from each other by the ion exchange membranes 11c and 12c.

The first channel 11, the second channel 12, and the third channel 13 may be fluidly connected to each other. For example, fluid in the third channel 13 may be movable to the first channel 11 and/or the second channel 12, and conversely, fluid in the first channel 11 and/or the second channel 12 may be movable to the third channel 13.

The cation exchange membrane 11c may include a membrane that allows only cations to pass through among cations and anions. The cation exchange membrane 11c carries a negative charge, allowing only cations to pass through while repelling anions.

The anion exchange membrane 12c may include a membrane that allows only anions to pass through among cations and anions. The anion exchange membrane 12c carries a positive charge, allowing only anions to pass through while repelling cations.

The ion exchange membranes 11c and 12c may include synthetic resin membranes.

In one or more embodiments, the housing may include the third channel inlet 102 to allow water to be introduced into the third channel 13, and the outlet 103 to allow deionized water or wastewater in the third channel 13 to be discharged.

Through the third channel inlet 102, water may be introduced into the third channel 13 from the outside of the deionization module 100. Through the outlet 103, water in the third channel 13 may be discharged to the outside of the deionization module 100.

The water treatment apparatus 1 may include a water source 15 where raw water is stored or to which raw water is supplied from the outside. The raw water may include water that is to be treated by the water treatment apparatus 1.

The water treatment apparatus 1 may include a pump 16a for pumping external water (e.g., water supplied from the water source).

The water treatment apparatus 1 may include the at least one flow path 20 and the at least one flow path valve unit 30. The at least one flow path 20 may be branched by the at least one valve unit 30.

The water pumped by the pump 16a may flow into the flow paths 20 of the water treatment apparatus 1.

In one or more embodiments, external water may be pumped by the pump 16a and flow into a first flow path 21. The first flow path 21 may be configured to receive the external water.

The first flow path 21 may be connected to the third channel inlet 102.

A first flow path valve 30a may open or close the first flow path 21. The first flow path valve 30a may block or allow water flow from the first flow path 21 to the third channel 13.

The water flowing into the third channel 13 through the first flow path 21 may be discharged to a second flow path 22. The second flow path 22 may be connected to the third channel outlet 103.

A second flow path valve 30b may allow water flowing on the second flow path 22 to flow into either a third flow path 23 or a fourth flow path 24. That is, the second flow path valve 30b may allow the water discharged from the third channel 13 to flow into either the third flow path 23 or the fourth flow path 24. In one or more embodiments, the second flow path valve 30b may close the second flow path 22 to prevent the water flowing on the second flow path 22 from flowing into the third flow path 23 or the fourth flow path 24.

The third flow path 23 may include a flow path through which purified water (or deionized water) is discharged. The fourth flow path 24 may include a flow path through which contaminated water (or wastewater) is discharged.

According to various embodiments, the number of third channel inlets 102, the number of third channel outlets 103, the type of flow path 20, and/or the type of valve unit 30 are not limited to the example shown in FIG. 1.

The water treatment apparatus 1 may include a concentration sensor 50 for detecting a concentration of an electrolyte aqueous solution in the deionization module 100.

According to one or more embodiments, the concentration sensor 50 may be located in the first channel 11.

According to one or more embodiments, the concentration sensor 50 may be located in the second channel 12.

The position of the concentration sensor 50 is not limited thereto, and any location suitable for detecting the concentration of the electrolyte aqueous solution inside the deionization module 100 may be employed as the location of the concentration sensor 50.

That is, the concentration detected by the concentration sensor 50 may correspond to the concentration of the electrolyte aqueous solution in the deionization module 100.

The water treatment apparatus 1 may include an electrolyte aqueous solution inside the first channel 11 and the second channel 12. The electrolyte aqueous solution may be supplied to the first channel 11 and the second channel 12 from the outside. The electrolyte aqueous solution may be supplied to the first channel 11 from the outside, and the electrolyte aqueous solution supplied to the first channel 11 may be supplied to the second channel 12.

The water treatment apparatus 1 may include an ion exchange resin layer 17 inside the third channel 13.

The ion exchange resin layer 17 may be configured in a form in which a cation exchange resin 17a and an anion exchange resin 17b are mixed.

The ion exchange resins 17a and 17b may be made of a polymer material, and may include a resin matrix accommodating exchanged ions, and functional groups located inside the resin matrix and substituting ions accommodated in the ion exchange resin layer with ions dissolved in water.

The ion exchange resins 17a and 17b may be classified into the cation exchange resin 17a and the anion exchange resin 17b according to the types of functional groups.

According to one or more embodiments, the ion exchange resin layer 17 may be implemented in a gel form in which the cation exchange resin 17a and the anion exchange resin 17b are densely arranged such that inter-particle spaces are minimized.

According to one or more embodiments, the ion exchange resin layer 17 may be implemented in a porous form in which spaces exist between the cation exchange resin 17a and the anion exchange resin 17b and a fine porous structure is formed inside the cation exchange resin 17a and the anion exchange resin 17b.

According to various embodiments, the water treatment apparatus 1 may include at least one deionization module 100. A plurality of deionization modules 100 may each include a capacitor formed by a pair of electrodes 11ab and 12ab, and the plurality of deionization modules 100 may be connected in series or parallel with each other.

In a case where the plurality of deionization modules 100 are connected in series with each other, the plurality of deionization modules 100 may each further include spacers for securing a space between each deionization module.

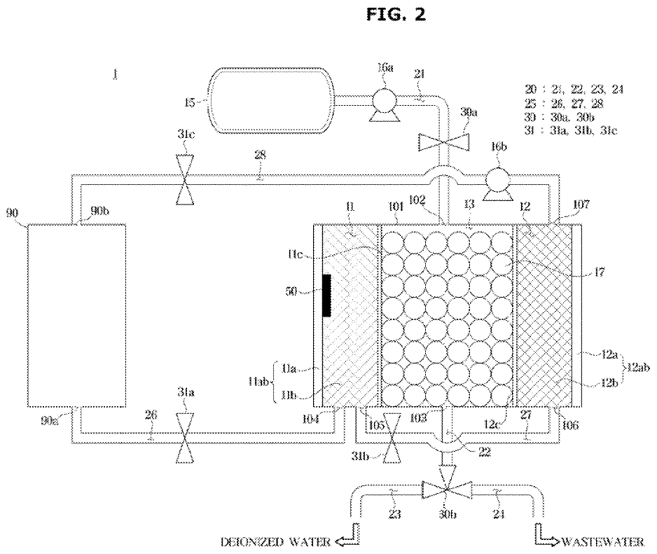

FIG. 2 is a conceptual diagram illustrating an example of the water treatment apparatus 1 including a storage tank 90 according to one or more embodiments.

According to one or more embodiments, the water treatment apparatus 1 may further include the storage tank 90 for storing an electrolyte solution.

In this instance, a concentration of the electrolyte solution stored in the storage tank 90 may be greater than or equal to 0.05M and less than or equal to 2M.

The storage tank 90 may be connected to the first channel 11 or the second channel 12 through flow paths to supply the electrolyte solution to the deionization module 100.

According to one or more embodiments, the storage tank 90 may include a storage tank inlet 90a through which the electrolyte aqueous solution flows from the deionization module 100 into the storage tank 90, and a storage tank outlet 90b for supplying the electrolyte aqueous solution stored in the storage tank 90 to the deionization module 100.

The first channel 11 may include a first channel inlet 104 through which the electrolyte aqueous solution flows from the storage tank 90, and a first channel outlet 105 for supplying the electrolyte aqueous solution from the first channel 11 to the second channel 12.

The second channel 12 may include a second channel inlet 106 through which the electrolyte aqueous solution flows from the first channel 11, and a second channel outlet 107 for discharging the electrolyte aqueous solution from the second channel 12 to the storage tank 90.

According to one or more embodiments, the water treatment apparatus 1 may include a circulation flow path 25 connecting the first channel 11, the second channel 12, and the third channel 13, and a circulation flow path valve unit 31 arranged on the circulation flow path 25.

For example, the circulation flow path 25 may include a circulation flow path 26 connecting the first channel inlet 104 and the storage tank outlet 90b, a circulation flow path 27 connecting the first channel outlet 105 and the second channel inlet 106, and a circulation flow path 28 connecting the second channel outlet 107 and the storage tank inlet 90a.

In addition, the circulation flow path valve unit 31 may include a first circulation flow path valve 31a arranged on the circulation flow path 26 connecting the first channel inlet 104 and the storage tank outlet 90b, a second circulation flow path valve 31b arranged on the circulation flow path 27 connecting the first channel outlet 105 and the second channel inlet 106, and a third circulation flow path valve 31c arranged on the circulation flow path 28 connecting the second channel outlet 107 and the storage tank inlet 90a.

According to one or more embodiments, the circulation flow path valve unit 31 may control circulation of the electrolyte aqueous solution among the first channel 11, the second channel 12, and the storage tank 90.

For example, the circulation flow path valve unit 31 including the first circulation flow path valve 31a, the second circulation flow path valve 31b, and the third circulation flow path valve 31c may open or close the circulation flow paths connecting the storage tank 90, the first channel 11, and the second channel 12 to allow or block the flow of the electrolyte aqueous solution.

That is, according to one or more embodiments, an electrolyte aqueous solution supply cycle of the storage tank 90→the first channel 11→the second channel 12→the storage tank 90 may be formed.

The electrolyte aqueous solution may flow from the storage tank 90 to the first channel 11 through the circulation flow path 26 connecting the first channel inlet 104 and the storage tank outlet 90b.

After the electrolyte aqueous solution flows into the first channel 11, the electrolyte aqueous solution may flow from the first channel 11 to the second channel 12 through the circulation flow path 27 connecting the first channel outlet 105 and the second channel inlet 106.

After the electrolyte aqueous solution flows into the second channel 12, the electrolyte aqueous solution may flow from the second channel 12 to the storage tank 90 through the circulation flow path 28 connecting the second channel outlet 107 and the storage tank inlet 90a.

In this instance, the electrolyte aqueous solution in the second channel 12 may be pumped by a pump 16b and flow to the storage tank 90.

In this instance, a concentration of the electrolyte aqueous solution flowing from the storage tank 90 into the first channel 11 may be higher than or equal to a concentration of the electrolyte aqueous solution discharged from the second channel 12 to the storage tank 90.

Also, a concentration of the electrolyte flowing from the first channel 11 into the second channel 12 may be higher than or equal to a concentration of the electrolyte discharged from the second channel 12 to the storage tank 90.

The water treatment apparatus 1 may flow a relatively low concentration electrolyte aqueous solution to the storage tank 90 and receive a relatively high-concentration electrolyte aqueous solution from the storage tank 90, thereby maintaining the concentration of the electrolyte aqueous solution accommodated in the deionization module 100 within a preset range.

According to various embodiments, the number of circulation flow paths 25 connecting the first channel 11, the second channel 12, and the storage tank 90 and the number of valve units 31 are not limited to the example shown in FIG. 2.

According to various embodiments, the water treatment apparatus 1 may include various components other than the circulation flow path valve unit 31 as a component for controlling the circulation of the electrolyte aqueous solution among the first channel 11, the second channel 12, and the storage tank 90.

According to various embodiments, the position and number of the circulation flow paths 25 and the circulation flow path valve units 31 may be determined so as to form an electrolyte aqueous solution cycle circulating through the first channel 11, the second channel 12, and the storage tank 90.

For example, the water treatment apparatus 1 may include the circulation flow path 25 connecting the second channel 12 and the storage tank 90 and the circulation flow path valve unit 31 arranged on the circulation flow path 25, to allow the electrolyte aqueous solution to flow from the storage tank 90 to the first channel 11.

In addition, the water treatment apparatus 1 may include the circulation flow path 25 connecting the first channel 11 and the storage tank 90 and the circulation flow path valve unit 31 arranged on the circulation flow path 25, to allow the electrolyte aqueous solution to flow from the second channel 12 to the storage tank 90.

The water treatment apparatus 1 according to one or more embodiments may have at least two operation modes. For example, the water treatment apparatus 1 according to one or more embodiments may have a deionization operation mode and a regeneration operation mode.

In addition, the water treatment apparatus 1 may further have a post-treatment operation mode.

A desalination operation mode includes the deionization operation mode, the regeneration operation mode, and the post-treatment operation mode, and the desalination operation mode may be repeatedly performed until the operation of the water treatment apparatus 1 ends after being started.

The water treatment apparatus 1 may perform a deionization process for water provided to the deionization module 100 in the deionization operation.

The water treatment apparatus 1 may perform a regeneration process for desorbing ions adsorbed on both electrodes 11ab and 12ab and the ion exchange resin layer 17 of the deionization module 100 in the regeneration operation.

In the post-treatment operation, the water treatment apparatus 1 may perform various processes for performing the deionization operation again, including a descaling process for removing scale generated on the electrodes 11ab and 12ab of the deionization module 100.

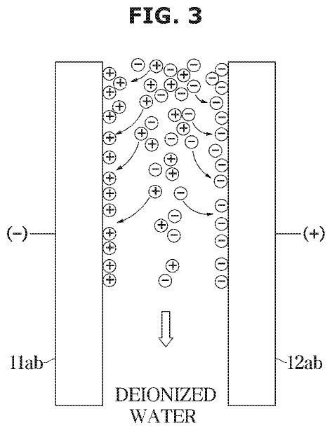

Hereinafter, movement of ions with respect to both electrodes 11ab and 12ab or the ion exchange resin layer 17 in the deionization operation or the regeneration operation is described with reference to FIG. 3 to FIG. 6.

FIG. 3 is a conceptual diagram illustrating movement of ions occurring at both electrodes 11ab and 12ab during a deionization operation of the water treatment apparatus 1 according to one or more embodiments.

According to one or more embodiments, when a negative voltage is applied between the first current collector 11a and the second current collector 12a, the first electrode 11ab becomes a negative electrode (cathode) and the second electrode 12ab becomes a positive electrode (anode).

Accordingly, when a negative voltage is applied between the first current collector 11a and the second current collector 12a, cations in the third channel 13 may move to the first channel 11, and anions in the third channel 13 may move to the second channel 12.

As a negative voltage is applied between the first current collector 11a and the second current collector 12a, cations moved to the first channel 11 may be adsorbed on the first porous electrode 11b, and anions moved to the second channel 12 may be adsorbed on the second porous electrode 12b.

Applying a negative voltage between the first current collector 11a and the second current collector 12a may include making a potential of the first current collector 11a lower than a potential of the second current collector 12a.

Also, applying a negative voltage between the first current collector 11a and the second current collector 12a may include applying a negative voltage to the first current collector 11a and applying a positive voltage to the second current collector 12a.

Accordingly, cations dissolved in water are adsorbed on the first porous electrode 11b, and thus deionized water from which cations are removed (i.e., deionized) from water may be generated.

That is, the deionization operation may refer to an operation in which a deionization reaction for removing cations contained in water flowing into the deionization module 100 occurs, and deionized water from which ions are removed is discharged to the outside of the deionization module 100.

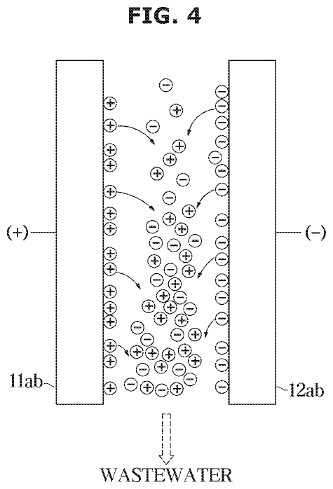

FIG. 4 is a conceptual diagram illustrating movement of ions occurring at both electrodes 11ab and 12ab during a regeneration operation of the water treatment apparatus 1 according to one or more embodiments.

When a positive voltage is applied between the first current collector 11a and the second current collector 12a, the first electrode 11ab becomes a positive electrode (anode) and the second electrode 12ab becomes a negative electrode (cathode). Accordingly, when a positive voltage is applied between the first current collector 11a and the second current collector 12a, cations in the first channel 11 may move to the third channel 13, and anions in the second channel 12 may move to the third channel 13.

Applying a positive voltage between the first current collector 11a and the second current collector 12a may include making a potential of the first current collector 11a higher than a potential of the second current collector 12a.

Applying a positive voltage between the first current collector 11a and the second current collector 12a may include applying a positive voltage to the first current collector 11a and applying a negative voltage to the second current collector 12a.

As a positive voltage is applied between the first current collector 11a and the second current collector 12a, cations adsorbed on the first porous electrode 11b may be desorbed from the first porous electrode 11b, and anions adsorbed on the second porous electrode 12b may be desorbed from the second porous electrode 12b.

Accordingly, cations desorbed from the first porous electrode 11b and anions desorbed from the second porous electrode 12b may be dissolved in water introduced from the third channel inlet 102, and thus the first porous electrode 11b and the second porous electrode 12b may be regenerated to a state capable of adsorbing ions again.

In addition, water in which ions desorbed from the first porous electrode 11b and the second porous electrode 12b are dissolved, that is, wastewater is generated.

That is, the regeneration operation may refer to an operation in which a deionization reaction for desorbing cations adsorbed on the first electrode 11ab, used as a negative electrode in the deionization operation, and moved to the third channel 13, occurs in an electrode cell 14, and wastewater containing a large amount of cations is discharged to the outside of the deionization module 100.

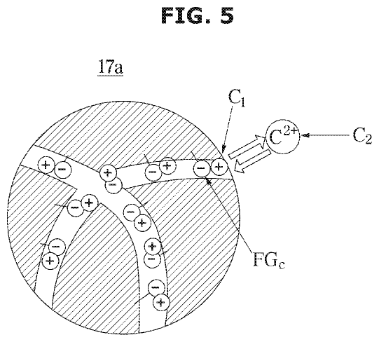

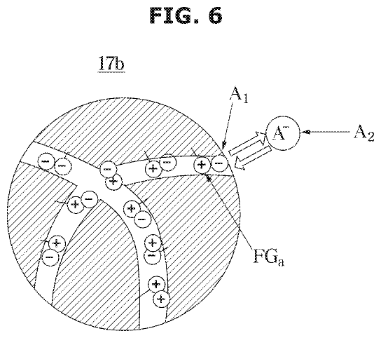

In the above, the movement of ions on both electrodes 11ab and 12ab in the desalination operation has been described. Hereinafter, movement of ions and chemical reaction at the ion exchange resin layer 17 during the desalination operation are described with reference to FIG. 5 and FIG. 6.

FIG. 5 is a conceptual diagram illustrating movement of ions and chemical reaction occurring at an interface of the cation exchange resin 17a.

The cation exchange resin 17a may include a plurality of functional groups that carry a negative charge inside the resin and are capable of ionic bonding with cations.

The plurality of functional groups may be dispersed at the resin interface and may chemically interact with cations.

For example, in a case where cations C₂, such as Ca²⁺, are dissolved in water around the cation exchange resin 17a, the following chemical reaction may occur.

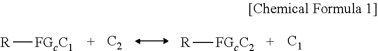

(FG corresponds to a functional group, and C₁ and C₂ correspond to cations.)

In this instance, the plurality of functional groups of the cation exchange resin 17a may remove cations from the water through ionic bonding with cations C₂ dissolved in water. In this instance, cations C₁ bonded to the plurality of functional groups before the reaction may be released into water as the ionic bond is broken.

Accordingly, cations C₂ dissolved in water are adsorbed on the cation exchange resin 17a, and thus deionized water from which cations are removed (i.e., deionized) from water may be generated.

That is, the deionization operation may refer to an operation in which a deionization reaction occurs in which the cation exchange resin 17a adsorbs and removes cations C₂ contained in water flowing into the deionization module 100, and deionized water from which ions are removed is discharged to the outside of the deionization module 100.

In contrast, in a case where water around the cation exchange resin 17a is a high-concentration electrolyte aqueous solution containing monovalent cations C₁, such as H⁺, a reverse reaction of the above Chemical Formula 1 may occur to reach an equilibrium state.

In this instance, it will be apparent to those skilled in the art that the same reaction may occur even in a case where water around the cation exchange resin 17a is a high-concentration electrolyte aqueous solution containing monovalent cations, such as Na⁺, in addition to H⁺.

That is, as the ionic bond between cations C₂ bonded in the deionization operation and the plurality of functional groups is broken, the cations C₂ bonded in the deionization operation may be released into water. In this instance, the plurality of functional groups may reduce the concentration of monovalent cations C₁ dissolved in the high concentration electrolyte through ionic bonding with monovalent cations C₁ dissolved in the high concentration electrolyte.

Accordingly, the cations C₂ bonded in the deionization operation and desorbed from the cation exchange resin 17a is dissolved in water, and thus the cation exchange resin 17a may be regenerated to a state where the forward reaction of Chemical Formula 1 may occur, that is, a state capable of adsorbing ions dissolved in water.

In addition, water in which cations C₂ bonded in the deionization operation and desorbed from the cation exchange resin 17a are dissolved, that is, wastewater is generated.

In other words, the regeneration operation may refer to an operation in which a deionization reaction for desorbing cations C₂ adsorbed on the cation exchange resin 17a in the deionization operation occurs and wastewater containing a large amount of cations C₂ is discharged to the outside of the deionization module 100.

The cation exchange resin 17a may be a strong acid cation exchange resin or a weak acid cation exchange resin.

The strong acid cation exchange resin according to one or more embodiments may have a sulfonate group (—SO₃H) as a functional group. The weak acid cation exchange resin according to one or more embodiments may have a carboxyl group (—COOH) as a functional group.

The strong acid cation exchange resin may be stably used over a wide pH range, but regeneration is not easy because its conjugate base is a weak base.

In contrast, the weak acid cation exchange resin may have reduced removal efficiency of cations dissolved in water at low pH, but regeneration is easier compared to the strong acid cation exchange resin.

FIG. 6 is a conceptual diagram illustrating movement of ions and chemical reaction occurring at an interface of the anion exchange resin 17b.

The anion exchange resin 17b may include a plurality of functional groups that carry a positive charge inside the resin and are capable of ionic bonding with anions.

The plurality of functional groups may be dispersed on the resin surface and may chemically interact with anions.

For example, in a case where anions A₂, such as Co₃⁻, are dissolved in water around the anion exchange resin 17b, the following chemical reaction may occur.

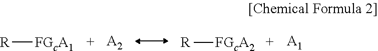

(FG corresponds to a functional group, and A₁ and A₂ correspond to anions.)

In this instance, the plurality of functional groups of the anion exchange resin 17b may remove anions from the water through ionic bonding with anions A₂ dissolved in water. In this instance, anions A₁ bonded to the plurality of functional groups before the reaction may be released into water as the ionic bond is broken.

Accordingly, anions A₂ dissolved in water are adsorbed on the anion exchange resin 17b, and thus deionized water from which anions are removed (i.e., deionized) from water may be generated.

That is, the deionization operation may refer to an operation in which a deionization reaction occurs in which the anion exchange resin 17b adsorbs and removes anions A₂ contained in water flowing into the deionization module 100, and deionized water from which ions are removed is discharged to the outside of the deionization module 100.

In contrast, in a case where water around the anion exchange resin 17b is a high-concentration electrolyte aqueous solution containing monovalent anions A₁, such as OH⁻, a reverse reaction of the above Chemical Formula 1 may occur to reach an equilibrium state.

In this instance, it will be apparent to those skilled in the art that the same reaction may occur even in a case where the water around the cation exchange resin 17a is a high-concentration electrolyte aqueous solution containing monovalent cations such as Cl— in addition to OH—.

That is, as the ionic bond between anions A₂ bonded in the deionization operation and the plurality of functional groups is broken, the anions A₂ bonded in the deionization operation may be released into water. In this instance, the plurality of functional groups may reduce the concentration of monovalent anions A₁ dissolved in the high concentration electrolyte through ionic bonding with monovalent anions A₁ dissolved in the high concentration electrolyte.

Accordingly, the anions A₂ bonded in the deionization operation and desorbed from the anion exchange resin 17b is dissolved in water, and thus the anion exchange resin 17b may be regenerated to a state where the forward reaction of Chemical Formula 2 may occur, that is, a state capable of adsorbing ions dissolved in water.

In addition, water in which anions A₂ bonded in the deionization operation and desorbed from the anion exchange resin 17b are dissolved, that is, wastewater is generated.

That is, the regeneration operation may refer to an operation in which a deionization reaction for desorbing anions A₂ adsorbed on the anion exchange resin 17b in the deionization operation occurs and wastewater containing a large amount of anions A₂ is discharged to the outside of the deionization module 100.

The anion exchange resin 17b may be a strong base cation exchange resin or a weak base cation exchange resin.

The strong base anion exchange resin according to one or more embodiments may have trimethylamine (TMA) and dimethylethanolamine (DMEA) as functional groups. The weak base anion exchange resin according to one or more embodiments may have tertiary amine as functional groups.

The strong base anion exchange resin may be stably used over a wide pH range, but regeneration is not easy because its conjugate acid is a weak acid.

In contrast, the weak base anion exchange resin may cause ion leakage due to reduced removal efficiency of cations dissolved in water at low pH, but regeneration is easier compared to the strong acid cation exchange resin.

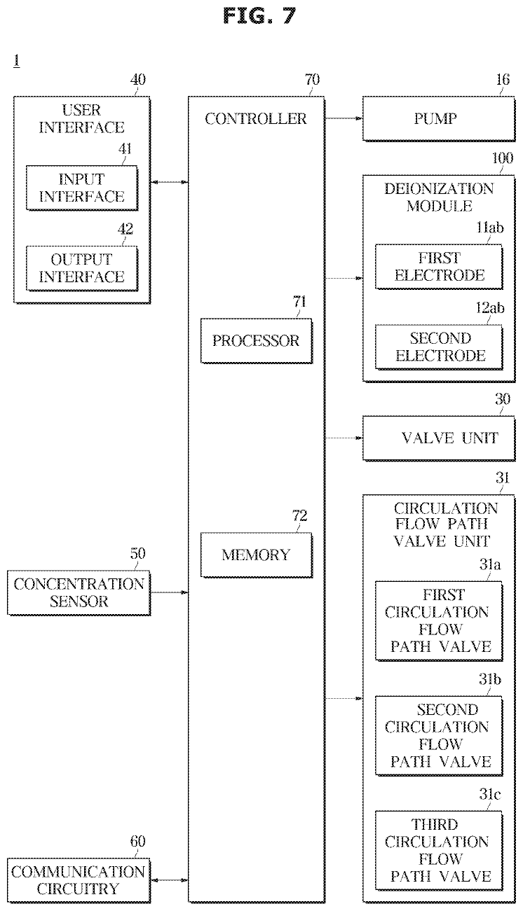

FIG. 7 is a control block diagram of the water treatment apparatus 1 according to one or more embodiments.

The water treatment apparatus 1 according to one or more embodiments may include a user interface 40, the concentration sensor 50, communication circuitry 60, the pump 16, the valve unit 30, a power supply device 80, the deionization module 100, and/or a controller 70.

The user interface 40 may include at least one input interface 41 and at least one output interface 42.

The at least one input interface 41 may convert sensory information received from a user (i.e., user input) into an electrical signal.

The at least one input interface 41 may include a power input interface for powering on the water treatment apparatus 1, an operation input interface for starting an operation of the water treatment apparatus 1, an operation mode selection input interface, and a setting input interface. The at least one input interface 41 may include, for example, a tact switch, a push switch, a slide switch, a toggle switch, a micro switch, a touch switch, a touch pad, a touch screen, a jog dial, and/or a microphone.

The operation mode selection input interface may include an interface for selecting an operation mode to be first operated, when the water treatment apparatus 1 starts operating via the operation input interface.

Through the operation mode selection input interface, an operator (user) of the water treatment apparatus 1 may select an operation mode to be started first among operation modes of the water treatment apparatus 1.

The setting input interface may include an interface for setting values for various components of the water treatment apparatus 1 (e.g., the pump 16, electrodes 11ab and 12ab, power supply device 80, circulation flow path valve 31).

For example, the setting input interface may include an interface for various settings, such as changing an operating revolutions per minute (RPM) of the pump 16 to adjust a flow rate of water supplied to the deionization module 100, or adjusting a magnitude of voltage applied to the electrodes 11ab and 12ab.

In addition, the setting input interface may include an interface for adjusting a driving voltage applied to the deionization module 100 by varying an output voltage output from the power supply device 80.

The at least one output interface 42 may generate sensory information to convey various information related to the operation of the water treatment apparatus 1 to a user.

For example, the at least one output interface 42 may convey, to a user, an operation time of the water treatment apparatus 1, information related to the settings of the water treatment apparatus 1, and information obtained from the hardness sensor 50.

For example, the at least one output interface 42 may convey, to a user, information about a time required when the water treatment apparatus 1 performs the deionization operation, the regeneration operation, or the post-treatment operation, or a total time required when performing each of the operations.

In another example, the at least one output interface 42 may convey, to a user, information about an output voltage output from the power supply device 80 at a time point when each operation starts or ends.

In addition, the at least one output interface 42 may also convey information about setting values input through the setting input interface to a user.

The information of the water treatment apparatus 1 may be output as a screen, an indicator, a voice, or the like.

The at least one output interface 42 may include, for example, a liquid crystal display (LCD) panel, a light emitting diode (LED) panel, a speaker, or the like.

The concentration sensor 50 may include at least one sensor for obtaining information related to a concentration of an electrolyte aqueous solution accommodated in the first channel 11.

The information obtained by the concentration sensor 50 may be transmitted to the controller 70.

The information obtained by the concentration sensor 50 may be output via the output interface 42.

The water treatment apparatus 1 may include the communication circuitry 60 for communicating with an external device (e.g., a server, a user device, and/or a home appliance) by wire and/or wirelessly.

The communication circuitry 60 may include at least one of a short-range wireless communication module or a long-range wireless communication module.

The communication circuitry 60 may transmit data to an external device or receive data from an external device. For example, the communication circuitry 60 may establish communication with a server, a user device, and/or a home appliance, and transmit and receive various data.

To this end, the communication circuitry 60 may support establishment of a direct (e.g., wired) communication channel or a wireless communication channel between external devices, and support communication through the established communication channel. According to one or more embodiments, the communication circuitry 60 may include a wireless communication module (e.g., a cellular communication module, a short-range wireless communication module, or a global navigation satellite system (GNSS) communication module) or a wired communication module (e.g., a local area network (LAN) communication module, or a power line communication module). A corresponding communication module among these communication modules may communicate with an external device via a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or WAN)). These various types of communication modules may be integrated into a single component (e.g., a single chip), or may be implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, a Zigbee communication module, an IrDA communication module, a WFD (Wi-Fi Direct) communication module, a ultrawideband (UWB) communication module, an Ant+ communication module, a microwave (uWave) communication module, etc., but is not limited thereto.

The long-range wireless communication module may include a communication module performing various types of long-range wireless communication, and may include mobile communication circuitry 60. The mobile communication circuitry 60 transmits and receives radio signals with at least one of a base station, an external terminal, or a server on a mobile communication network.

In an embodiment, the communication circuitry 60 may communicate with an external device such as a server, a user device, a home appliance, etc., through a nearby access point (AP). The access point (AP) may connect a local area network (LAN) to which the water treatment apparatus 1, the home appliance, and/or the user device are connected to a wide area network (WAN) to which the server is connected. The water treatment apparatus 1, the home appliance, and/or the user device may be connected to the server through the wide area network (WAN).

The communication circuitry 60 may receive information about hardness of water introduced through the third channel inlet 102 from an external device.

For example, in a case where a sensor for detecting hardness of water discharged through the third channel inlet 102 is installed outside of the water treatment apparatus 1, the communication circuitry 60 may receive information about the hardness of water discharged through the third channel inlet 102 from the sensor installed outside the water treatment apparatus 1.

The information obtained by the communication circuitry 60 may be transmitted to the controller 70.

The communication circuitry 60 may transmit information about water obtained from the concentration sensor 50 and a water quality sensor to an external device (e.g., a server, a user device, a home appliance).

The controller 70 may include hardware, such as a central processing unit (CPU), Micom, or memory, and software such as a control program. For example, the controller 70 may include at least one memory 72 storing data in the form of algorithms, programs, and the like, for controlling operations of components of the water treatment apparatus 1, and at least one processor 71 performing the aforementioned operations and operations to be described below using the data stored in the at least one memory 72. The memory 72 and the processor 71 may be implemented as separate chips. The processor 71 may include one or two or more processor chips, or one or two or more processing cores. The memory 72 may include one or two or more memory chips, or one or two or more memory blocks. In addition, the memory 72 and the processor 71 may be implemented as a single chip.

The controller 70 may be electrically connected to the pump 16, the user interface 40, the concentration sensor 50, the communication circuitry 60, the power supply device 80, the deionization module 100, and/or the valve unit 30.

The controller 70 may control various components of the water treatment apparatus 1 (e.g., the user interface 40, the hardness sensor 50, the communication circuitry 60, the pump 16, the power supply device 80, the deionization module 100, the valve unit 30, and/or the circulation flow path valve unit 31).

The controller 70 may control the pump 16a to pump water stored in the water source 15 to the first flow path 21.

The controller 70 may control the pump 16b to pump the electrolyte aqueous solution accommodated in the second channel 12 to the storage tank 90.

The controller 70 may control the valve unit 30 to change the flow of water flowing in the at least one flow path of first flow path 21, second flow path 22, third flow path 23, and fourth flow path 24.

The controller 70 may control the circulation flow path valve unit 31 to change the flow of the electrolyte aqueous solution flowing in the at least one circulation flow path of circulation flow path 25, circulation flow path 26, and circulation flow path 27.

The controller 70 may control the circulation flow path valve unit 31 to allow the electrolyte aqueous solution to be supplied to at least one of the first channel 11 or the second channel 12.

That is, the controller 70 may control the circulation flow path valve unit 31 to form an electrolyte aqueous solution circulation cycle of the storage tank 90→the first channel 11→the second channel 12→the storage tank 90.

The controller 70 may turn on the circulation flow path valve unit 31 based on the concentration detected by the concentration sensor 50 being less than or equal to a preset minimum concentration.

The controller 70 may turn off the circulation flow path valve unit 31 based on the concentration detected by the concentration sensor 50 being greater than or equal to a preset maximum concentration.

Accordingly, the controller 70 may control the circulation flow path valve unit 31 to maintain the concentration of the electrolyte aqueous solution accommodated in the deionization module 100 within a preset range.

The controller 70 may control a magnitude of voltage applied between the first electrode 11ab and the second electrode 12ab.

That is, the controller 70 may control a magnitude of an output voltage of the power supply device 80 to control a magnitude of a driving voltage applied to the deionization module 100, thereby controlling the magnitude of the voltage applied between the first electrode 11ab and the second electrode 12ab. For example, the controller 70 may control the power supply device 80 so that the output voltage varies continuously or in a stepwise manner over time.

In addition, the controller 70 may control the power supply device 80 based on a user input received via the user interface 40 (e.g., an output voltage of the power supply device 80 input by a user).

The power supply device 80 may be connected to an external power source and may provide power required for the operation of the water treatment apparatus 1. That is, the power supply device 80 may provide power to electronic components included in the water treatment apparatus 1.

The power supply device 80 may include a power circuit, a switching circuit, and a variable circuit for varying an output voltage, and may be electrically connected to the controller 70.

The power supply device 80 may provide a constant voltage or a variable voltage to the at least one electrode cell 14 according to the operation mode of the water treatment apparatus 1 under control of the controller 70.

The power supply device 80 may include a switching mode power supply device (SMPS) to vary the output voltage. The SMPS may convert alternating current (AC) power into direct current (DC) power and supply DC power. The SMPS may provide two types of power in which switching pulses operate differently. The first power may be power going from a forward direction to a reverse direction, and the second power may be power going from a reverse direction to a forward direction. Through high-frequency switching via the SMPS power, current may be reduced while maintaining voltage, thereby reducing overall power without performance reduction.

The power supply device 80 may include a pulse width modulation (PWM) module, a variable resistor, or a feedback loop to vary the output voltage.

The power supply device 80 may include components required to vary the output voltage in addition to the aforementioned components.

According to one or more embodiments, because the first electrode 11ab and the second electrode 12ab disposed opposite to each other may form a capacitor, the relationship between the output voltage, output from the power supply device 80 and applied to the deionization module 100, and the adsorption/desorption efficiency of hardness components in each electrode cell 14 is described below with reference to FIG. 5.

According to one or more embodiments, the water treatment apparatus 1 may include the first electrode 11ab in the first channel 11, the second electrode 12ab in the second channel 12, and the ion exchange resin layer 17 in the third channel 13.

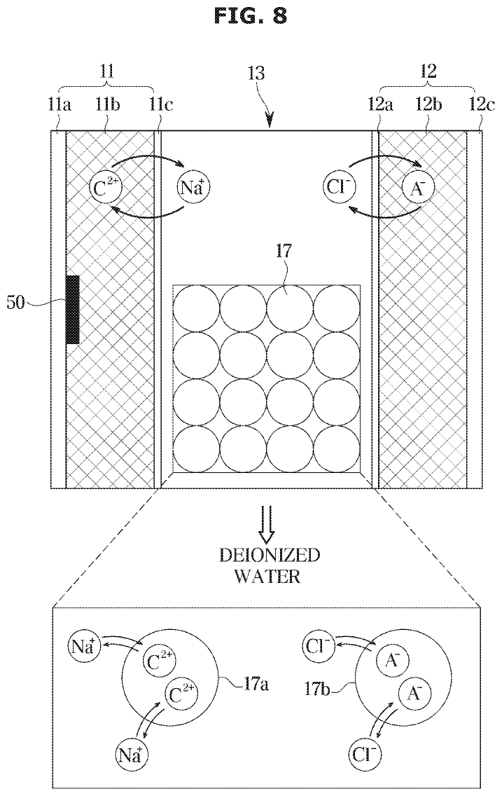

According to one or more embodiments, a process in which the water treatment apparatus 1 removes hardness components in the deionization operation and regenerates both electrodes 11ab and 12ab and the ion exchange resin layer 17 in the regeneration operation is described with reference to FIG. 8 to FIG. 13.

In this instance, the hardness components may include various inorganic substances dissolved in water, particularly various metal ions (e.g., calcium Ca²⁺ and magnesium Mg²⁺).

Removing hardness components from water may include removing inorganic substances or metal ions (e.g., calcium Ca²⁺ and magnesium Mg²⁺) dissolved in water.

FIG. 8 is a diagram illustrating a process of removing ions from water during a deionization operation of the water treatment apparatus 1 according to one or more embodiments.

According to one or more embodiments, when a negative voltage is applied between the first electrode 11ab and the second electrode 12ab by the controller 70 (i.e., when a negative voltage is applied to the first electrode 11ab), the first electrode 11ab may become a negative electrode and the second electrode 12ab may become a positive electrode.

That is, in the deionization operation, the first electrode 11ab may become a negative electrode and the second electrode 12ab may become a positive electrode.

According to one or more embodiments, in the deionization operation, the water treatment apparatus 1 may remove ions, dissolved in water introduced from the third channel inlet 102, from the water through two methods to generate deionized water.

As the first method, ions dissolved in water may be adsorbed on both electrodes 11ab and 12ab in the form of an electric double layer.

As a negative voltage is applied to both electrodes 11ab and 12ab by the controller 70, ions dissolved in water may move to both electrodes 11ab and 12ab by electrical attraction.

Specifically, cations may pass through the cation exchange membrane 11c and move from the third channel 13 to the surface of the first electrode 11ab of the first channel 11, and anions may pass through the anion exchange membrane 12c and move from the third channel 13 to the second electrode 12ab of the second channel 12. The moved ions may be stored on the surfaces of both electrodes 11ab and 12ab in the form of an electric double layer.

As the second method, ions dissolved in water may be adsorbed on the ion exchange resin layer 17 due to the ion exchange principle.

As water introduced from the third channel inlet 102 passes through the ion exchange resin layer 17, ions dissolved in water may be adsorbed on the ion exchange resins 17a and 17b by ionic bonding with charged functional groups.

The cation exchange resin 17a having negatively charged functional groups may remove cations dissolved in water through ionic bonding with cations dissolved in water, and the anion exchange resin 17b having positively charged functional groups may remove anions dissolved in water through ionic bonding with anions dissolved in water.

According to the two methods, ions contained in water flowing into the deionization module 100 may be removed, and deionized water from which ions are removed may be discharged to the outside of the deionization module 100.

The water treatment apparatus 1 according to one or more embodiments may remove ions including hardness components dissolved in water through the above two methods, thereby achieving higher deionization efficiency compared to a water treatment apparatus equipped with only a CDI module that removes hardness components by forming an electric double layer, or only an EDI module equipped with an ion exchange resin layer to remove hardness components.

According to one or more embodiments, the water treatment apparatus 1 may accommodate an electrolyte aqueous solution in the first channel 11 or the second channel 12.

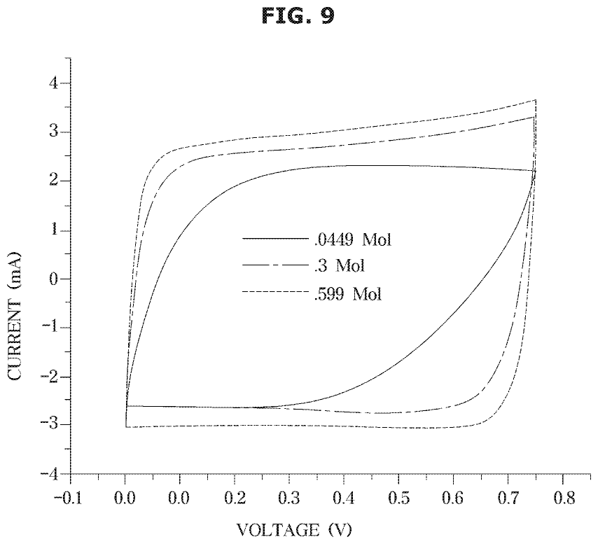

The water treatment apparatus 1 accommodates the electrolyte aqueous solution therein, and thus deionization efficiency may be further increased, which is described below with reference to FIG. 9.

FIG. 9 is a diagram illustrating that deionization efficiency is increased by supplying an electrolyte solution to a deionization module according to one or more embodiments.

In FIG. 9, the x-axis represents applied voltage V, and the y-axis represents current value mA according to the applied voltage.

The graphs of FIG. 9 represent capacitance of an activated carbon electrode measured by cyclic voltammetry (CV), when NaCl electrolyte concentrations are 0.449 Mol, 0.3 Mol, and 0.599 Mol, respectively.

In this instance, the capacitance may be proportional to a value obtained by multiplying the applied voltage V and the current value mA according to the applied voltage. That is, it may be interpreted that the larger the area of the CV graph, the larger the capacitance.

The capacitance may correspond to deionization efficiency in the CDI module.

According to the graphs of FIG. 9, as the electrolyte concentration increases, the area of the CV graph increases.

That is, the higher the electrolyte concentration, the higher the capacitance. The increase in capacitance indicates that the ability of the electrode to store ions on the surface increases, and thus the deionization efficiency in the CDI module increases.

In an existing water treatment apparatus including a CDI module, water flowing into the deionization module 100 (i.e., water treated by the deionization module 100) rapidly becomes an electrolyte aqueous solution, and thus the concentration of the electrolyte may not increase beyond a preset concentration, and capacitance is constrained.

However, the water treatment apparatus 1 according to one or more embodiments may maximize the capacitance of both electrodes 11ab and 12ab by supplying a separate electrolyte aqueous solution to the first channel 11 or the second channel 12.

Specifically, the controller 70 may control the circulation flow path valve unit 31 to supply a high-concentration electrolyte aqueous solution stored in the storage tank 90 to at least one of the first channel 11 or the second channel 12, thereby increasing the capacitance of the first electrode 11ab in the first channel 11 and the second electrode 12ab in the second channel 12.

That is, the water treatment apparatus 1 according to one or more embodiments may include the storage tank 90 separately, and supply the deionization module 100 with an electrolyte aqueous solution having a higher concentration than water flowing into the third channel 13 through the third channel inlet 102 (i.e., water treated by the deionization module 100), thereby increasing deionization efficiency in the deionization operation.

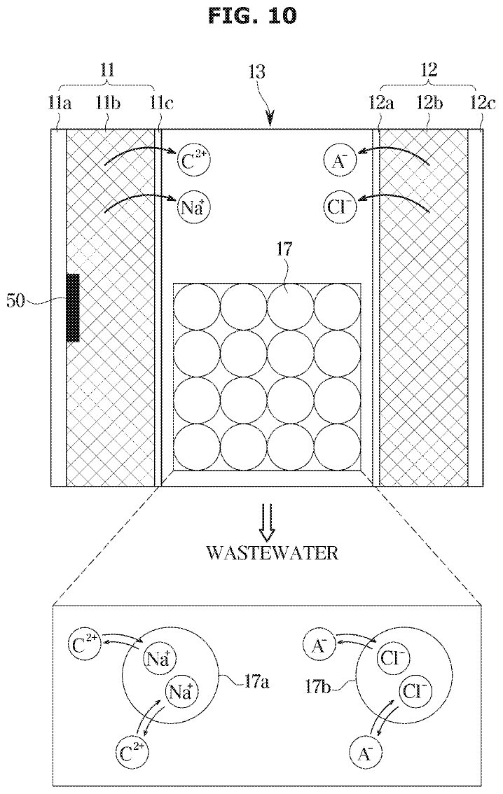

FIG. 10 is a diagram illustrating a process of regenerating both electrodes and the ion exchange resin layer during a regeneration operation of the water treatment apparatus according to one or more embodiments.

According to one or more embodiments, when a positive voltage is applied between the first electrode 11ab and the second electrode 12ab by the controller 70 (i.e., when a positive voltage is applied to the first electrode 11ab), the first electrode 11ab may become a positive electrode and the second electrode 12ab may become a negative electrode.

That is, in the regeneration operation, the first electrode 11ab may become a positive electrode and the second electrode 12ab may become a negative electrode.

According to one or more embodiments, in the regeneration operation, the water treatment apparatus 1 may desorb hardness components adsorbed on both electrodes 11ab and 12ab and the ion exchange resin layer 17 through two methods, and then discharge the hardness components to generate wastewater.

As the first method, a reverse voltage may be applied to both electrodes 11ab and 12ab to desorb ions adsorbed in the form of an electric double layer, thereby regenerating both electrodes 11ab and 12ab.

In the regeneration operation, the controller 70 may apply a reverse voltage of the voltage applied in the deionization operation to both electrodes 11ab and 12ab.

In this instance, as a positive voltage is applied to both electrodes 11ab and 12ab by the controller 70, ions adsorbed on both electrodes 11ab and 12ab in the form of an electric double layer may be desorbed by electrical repulsion.

Specifically, cations may be desorbed from the first electrode 11ab, pass through the cation exchange membrane 11c, and move to the third channel 13, and anions may be desorbed from the second electrode 12ab, pass through the anion exchange membrane 12c, and move to the third channel 13.

Cations and anions moved to the third channel 13 may be dissolved in water introduced into the third channel 13.

As the second method, ions adsorbed on the ion exchange resin layer 17 may be desorbed due to the ion exchange principle, thereby regenerating the ion exchange resin layer 17.

For example, by supplying a high-concentration NaCl aqueous solution from the storage tank 90 to the first channel 11 or the second channel 12, Na⁺ of the first channel 11 may pass through the cation exchange membrane 11c and be supplied to the third channel 13, and Cl⁻ of the second channel 12 may pass through the anion exchange membrane 12c and be supplied to the third channel 13.

As a large amount of Na⁺ and Cl⁻ are supplied to the ion exchange resin layer 17 in the third channel 13, reverse reactions of the aforementioned Chemical Formula 1 and Chemical Formula 2 may occur due to the tendency to reach an equilibrium state as described above with reference to FIG. 5 and FIG. 6.

Accordingly, ions adsorbed on the ion exchange resin layer 17 may be desorbed, and thus the ion exchange resin layer 17 may be regenerated.

That is, the ionic bond between the cations adsorbed on the cation exchange resin 17a having negatively charged functional groups and the anions adsorbed on the anion exchange resin 17b having positively charged functional groups is broken, thereby removing ions adsorbed on the ion exchange resin layer 17.

In this instance, the removed ions may flow into the third channel 13 through the third channel inlet 102 and may be dissolved in water passing through the ion exchange resin layer 17, thereby generating wastewater.

According to the two methods, both electrodes 11ab and 12ab and the ion exchange resin layer 17 of the deionization module 100 may be regenerated, and wastewater containing desorbed ions may be discharged to the outside of the deionization module 100.

An existing water treatment apparatus equipped with only an electrodeionization (EDI) module regenerates an ion exchange resin layer by flowing separate chemicals, such as alkaline aqueous solutions and acidic aqueous solutions, to electrodes and an ion exchange resin layer. Accordingly, secondary contamination may occur due to chemicals.

However, the water treatment apparatus 1 according to one or more embodiments that receives a high-concentration electrolyte solution from the storage tank 90 may regenerate the ion exchange resin layer 17 by increasing the concentration of monovalent ions in the deionization module 100, and thus the ion exchange resin layer 17 may be regenerated without separate chemicals.

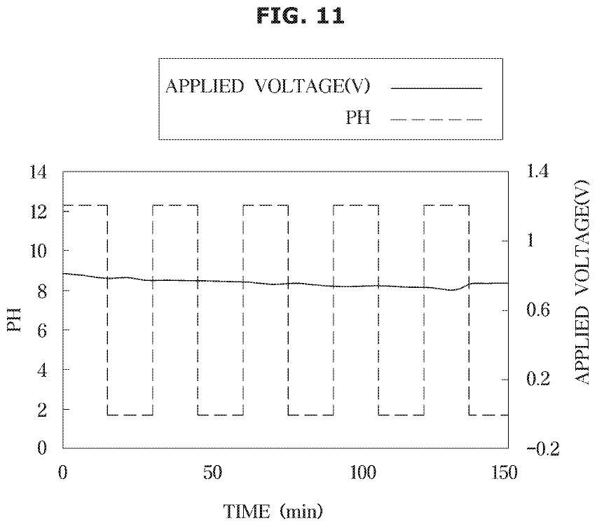

In addition, the water treatment apparatus 1 according to one or more embodiments that receives a high-concentration electrolyte solution from the storage tank 90 may reduce scale generation (scaling) because the pH change range is narrow in the regeneration process, which will be described below with reference to FIG. 11 to FIG. 13.

Scale may be generated by metal cations (e.g., Ca²⁺) dissolved in water.

In general, scale may be formed easily as pH increases (i.e., as OH⁻ increases), and may be easily formed in a corresponding portion even when pH increases locally.

Scale generated at an electrode interface may prevent ions from being adsorbed in the form of an electric double layer at the electrode interface, thereby reducing deionization efficiency.

Thus, scale generation is a critical issue in water softening devices, and a method for reducing scale generation is required in using the water treatment apparatus 1 for home appliances using water (e.g., dishwashers, washing machines, etc.).

FIG. 11 is a diagram illustrating pH change during a regeneration operation in a CDI module.

In FIG. 11, the x-axis represents time (minutes), and the y-axis represents applied voltage V or pH change of the CDI module.

The solid line graph of FIG. 11 represents the magnitude of voltage applied to the CDI module over time, and the dotted line graph represents the pH change of water in the CDI module over time.

In operating the CDI module, theoretically, because the magnitude of voltage applied to both electrodes is lower than a voltage at which water dissociation occurs (hereinafter referred to as ‘water dissociation generation voltage’), there is little or no OH— generation due to water dissociation, and thus no pH change occurs.

The water dissociation generation voltage may correspond to approximately 1.25V.

However, referring to FIG. 11, it may be seen that pH changes significantly even in a case where a constant voltage between 0.7V and 0.8V is applied to both electrodes.

In the CDI module, water introduced for deionization rapidly becomes an electrolyte without supply of a separate electrolyte aqueous solution, which causes side reactions between electrodes and oxygen in water during deionization operation and regeneration operation and generation of OH—.

The side reaction may include an oxidation reaction of carbon and water and a reduction reaction of dissolved oxygen at the electrode of the deionization module 100 made of carbon.

That is, even in a case where a voltage lower than the water dissociation generation voltage is applied to the CDI module, pH may change significantly depending on the type, amount, and movement of ions dissolved in water.

Thus, scale generation is likely to occur in a water treatment apparatus including only a CDI module.

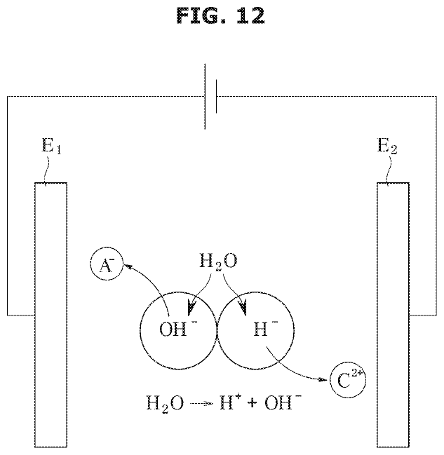

FIG. 12 is a diagram illustrating pH change during a regeneration operation in an EDI module.

Referring to FIG. 11, when voltage is applied to both electrodes E1 and E2 to regenerate an ion exchange resin layer in the EDI module, chemical reactions and ion movement may occur at the ion exchange resin layer between both electrodes E1 and E2.

In the EDI module, a voltage higher than or equal to the water dissociation generation voltage is applied between both electrodes E1 and E2 to regenerate the ion exchange resin layer, thereby generating H⁺ and OH⁻ ions according to a water dissociation reaction.

In a case where the water dissociation reaction occurs around a cation exchange resin interface, the cation exchange resin may desorb cations (e.g., Ca2+) adsorbed from water as the generated H+ bonds to a functional group of the cation exchange resin.

In this instance, pH around the cation exchange resin interface may locally increase significantly due to generated OH⁻.

Accordingly, cations (e.g., Ca²⁺) desorbed from the cation exchange resin, existing around the cation exchange resin interface, may form scale.

That is, scale generation is also likely to occur in a water treatment apparatus including only an EDI module.

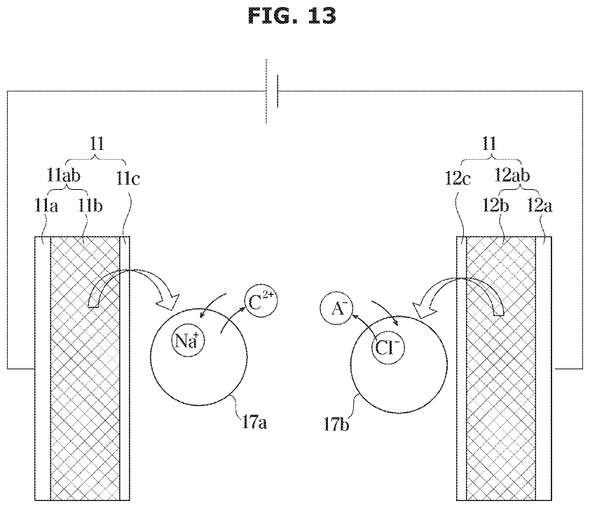

FIG. 13 is a diagram illustrating pH change during a regeneration operation of the water treatment apparatus 1 according to one or more embodiments in comparison with FIG. 12 and FIG. 13.

The deionization module 100 according to one or more embodiments may receive an electrolyte aqueous solution from the storage tank 90 during a regeneration operation.

For example, the deionization module 100 may receive a NaCl aqueous solution from the storage tank 90 during the regeneration operation.

In this instance, the controller 70 may apply a reverse voltage of the voltage applied in the deionization operation to both electrodes 11ab and 12ab, and thus the first electrode 11ab may become a positive electrode and the second electrode 12ab may become a negative electrode.

In this instance, Na⁺ ions in the NaCl aqueous solution supplied to the first channel 11 may pass through the cation exchange membrane 11c by repulsion and move to the third channel 13.

Cl⁻ ions in the NaCl aqueous solution supplied to the second channel 12 may pass through the anion exchange membrane 12c by repulsion and move to the third channel 13.

That is, by supplying a large amount of NaCl aqueous solution to the deionization module 100 during the regeneration operation, a large amount of Na⁺ ions and Cl⁻ ions may be supplied to the third channel 13.

As a large amount of Na⁺ ions and Cl⁻ ions are supplied, the ion exchange resin layer 17 in the third channel 13 may regenerate the ion exchange resins 17a and 17b using the supplied Na⁺ and Cl⁻ ions without generation of H⁺ and OH⁻ ions through water dissociation.

That is, the cation exchange resin 17a may desorb cations adsorbed from water in the deionization operation and may adsorb supplied Na⁺ ions, and thus a water dissociation reaction may not occur at the cation exchange resin 17a interface.

Accordingly, because a pH change due to occurrence of water dissociation does not occur at the cation exchange resin 17a interface, scale generation may be reduced.

In addition, as the deionization module 100 may receive the NaCl aqueous solution from the storage tank 90 during the regeneration operation, side reactions of both electrodes may be suppressed. Accordingly, a pH change at the negative electrode may be suppressed, thereby reducing scale generation.

In the disclosure, although it has been described that the aqueous solution stored in the storage tank 90 is a NaCl aqueous solution, this is merely an example. It will be apparent to those skilled in the art that the same effect may be obtained even in a case where other electrolyte aqueous solutions, other than the NaCl aqueous solution, are stored in the storage tank 90 and supplied to the deionization module 100.

As described above, advantages of the water treatment apparatus 1 including the EDI module and the CDI module receiving the electrolyte aqueous solution from the storage tank 90 have been described in comparison with an existing water treatment apparatus including only one of the EDI module or the CDI module without supply of an electrolyte aqueous solution.

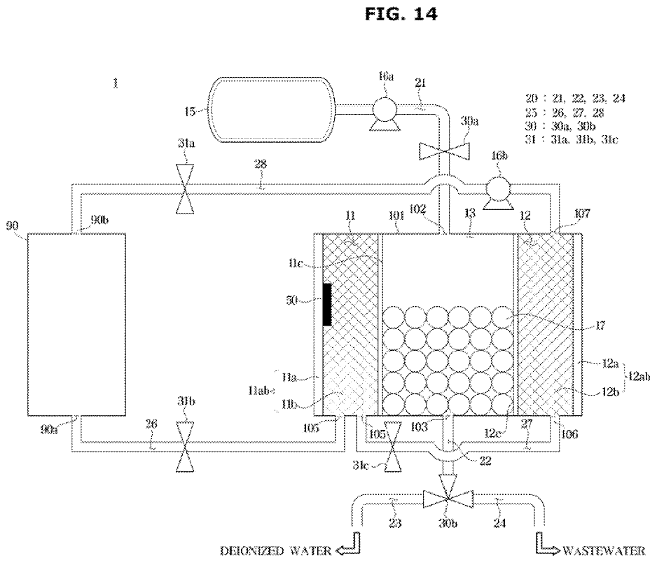

Hereinafter, a structure of the water treatment apparatus 1 including the storage tank 90 according to another embodiment is described with reference to FIG. 14.

FIG. 14 is a conceptual diagram illustrating an example of a water treatment apparatus including a storage tank according to another embodiment.

According to one or more embodiments, the ion exchange resin layer 17 accommodated in the third channel 13 may be located only in a portion of the third channel 13.

For example, in the water treatment apparatus 1 according to another embodiment, only the CDI module may be provided at an upper portion of the third channel 13, and both the CDI module and the EDI module may be provided at a lower portion of the third channel 13.

Accordingly, during a deionization operation, ions dissolved in water may be removed only by the CDI module at the upper portion adjacent to the third channel inlet 102 through which water flows into the third channel 13.

Specifically, cations pass through the cation exchange membrane 11c and move to the first channel 11, and anions pass through the anion exchange membrane 12c and move to the second channel 12, and thus ions dissolved in water may be primarily removed.

On the other hand, as water first deionized by the CDI module at the upper portion flows through the ion exchange resin layer 17 at the lower portion of the third channel 13, ions may be removed by the EDI module while passing through the ion exchange resin layer 17, in addition to desalination by the CDI module.

That is, the cation exchange resin 17a of the ion exchange resin layer 17 may adsorb cations of the primarily deionized water, and the anion exchange resin 17b may adsorb anions of the primarily deionized water, and thus desalination may be performed by the EDI module.

The water treatment apparatus 1 according to another embodiment may include a portion of the third channel 13 in which the ion exchange resin 70 is not provided, thereby reducing a load on the ion exchange resin 70. In addition, water that has been deionized at the upper portion may be secondarily deionized by the CDI module and the EDI module at the lower portion, thereby increasing deionization efficiency.

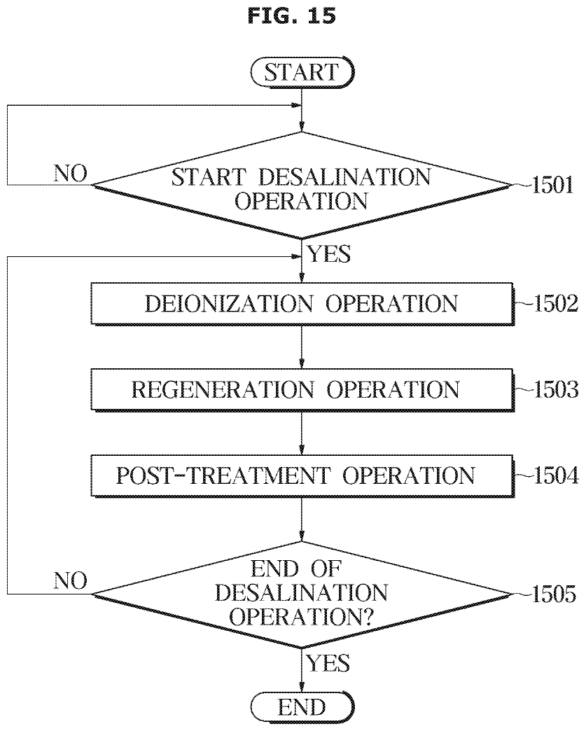

FIG. 15 is a schematic diagram illustrating operating sequences of a water treatment apparatus according to one or more embodiments.

Referring to FIG. 15, the water treatment apparatus 1 according to one or more embodiments may perform a deionization operation, a regeneration operation, and/or a post-treatment operation during a desalination operation.

The controller 70 may start the desalination operation based on receiving an input to start the desalination operation via the user interface 40 (1501). The controller 70 may start the desalination operation under a preset condition even in a case where the user interface 70 does not receive the input to start the desalination operation.

In this instance, starting the desalination operation may refer to the controller 70 controlling the power supply device 80 to apply an output voltage to the CDI module 100, indicating that the deionization operation is started during the desalination operation.

The controller 70 may control the water treatment apparatus 1 to perform the deionization operation (1502).

The deionization operation may refer to an operation of removing ions contained in water flowing into the deionization module 100 and discharging deionized water from which ions are removed to the outside of the deionization module 100.

The water treatment apparatus 1 may apply a negative voltage to the first current collector 11a in the deionization operation.

Applying a negative voltage to the first current collector 11a may include applying a positive voltage to the second current collector 12a.

Applying a negative voltage to the first current collector 11a may include applying a negative voltage between the first current collector 11a and the second current collector 12a.

Applying a negative voltage between the first current collector 11a and the second current collector 12a may include ensuring that a difference between a voltage applied to the first current collector 11a and a voltage applied to the second current collector 12a becomes a negative voltage.

Applying a negative voltage to the first current collector 11a may include applying a positive voltage between the second current collector 12a and the first current collector 11a.

Applying a positive voltage between the second current collector 12a and the first current collector 11a may include ensuring that a difference between a voltage applied to the second current collector 12a and a voltage applied to the first current collector 11a becomes a positive voltage.

The controller 70 may cause cations contained in water in the third channel 13 to move to the first channel 11 by applying a negative voltage to the first current collector 11a in the deionization operation.

In the deionization operation, cations in the third channel 13 may move to the second channel 12 through the cation exchange membrane 12c and may be adsorbed on the second porous electrode 12b.

In addition, the controller 70 may cause cations to be adsorbed on the cation exchange resin 17a of the ion exchange resin layer 17 of the third channel 13 by applying a negative voltage to the first current collector 11a in the deionization operation.

When the deionization operation ends, the controller 70 may control the water treatment apparatus 1 to perform the regeneration operation (1503).

The regeneration operation may refer to an operation of desorbing cations adsorbed on the first electrode 11ab used as a negative electrode in the deionization operation, moving the desorbed cations to the third channel 13, and discharging wastewater containing a large amount of cations to the outside of the deionization module 100.

The water treatment apparatus 1 may apply a positive voltage to the first current collector 11a in the regeneration operation.

Applying a positive voltage to the first current collector 11a may include applying a negative voltage to the second current collector 12a.

Applying a positive voltage to the first current collector 11a may include applying a positive voltage between the first current collector 11a and the second current collector 12a.

Applying a positive voltage between the first current collector 11a and the second current collector 12a may include ensuring that a difference between a voltage applied to the first current collector 11a and a voltage applied to the second current collector 12a becomes a positive voltage.

Applying a positive voltage to the first current collector 11a may include applying a negative voltage between the second current collector 12a and the first current collector 11a.

Applying a negative voltage between the second current collector 12a and the first current collector 11a may include ensuring that a difference between a voltage applied to the second current collector 12a and a voltage applied to the first current collector 11a becomes a negative voltage.

The controller 70 may cause cations in the first channel 11 to move to the third channel 13 by applying a positive voltage to the first current collector 11a in the regeneration operation.

In addition, the controller 70 may cause cations of the electrolyte aqueous solution supplied to the first channel 11 to move to the third channel 13 by applying a positive voltage to the first current collector 11a in the regeneration operation.

Accordingly, cations adsorbed on the cation exchange resin 17a of the ion exchange resin layer 17 during the deionization operation may be desorbed due to an increase in the concentration of cations of the electrolyte aqueous solution in the third channel 13.

The desorbed cations may pass through the cation exchange membrane 11c and be dissolved in water flowing in the third channel 13.

Unlike an existing water treatment apparatus including an EDI module, the water treatment apparatus 1 according to one or more embodiments does not require regeneration of the ion exchange resin layer 17 through electrolysis of water. Accordingly, a magnitude of the positive voltage applied to the first current collector 11a in the regeneration operation may be preset within a range in which water is not electrolyzed.

Thus, the magnitude of the positive voltage applied to the first current collector 11a in the regeneration operation is may be less than or equal to a water dissociation generation voltage.

When the regeneration operation ends, the controller 70 may start the post-treatment operation (1504).

The controller 70 may control components of the water treatment apparatus 1 to perform various processes for performing the deionization operation again. For example, the controller 70 may control the power supply device 80 to perform a descaling process of removing generated scale.

The controller 70 may determine whether an input to end the desalination operation is received via the user interface 70 (1505).

The controller 70 may end the desalination operation under a preset condition even in a case where the user interface 70 does not receive the input to end the desalination operation.

The controller 70 may also determine whether a preset condition for terminating the desalination operation exists.

In a case where the input to end the desalination operation exists or the preset condition exists (Yes in operation 1505), the controller 70 may control the power supply device 80 so that power is not output from the power supply device 80.

In a case where the input to end the desalination operation does not exist and the preset condition does not exist (No in operation 1505), the controller 70 may control the water treatment apparatus 1 to perform the deionization operation again.

That is, based on the absence of the input to end desalination operation and the preset condition (No in operation 1505), the controller 70 may repeat the deionization operation and/or the regeneration operation according to a predetermined cycle.

The order, operation time, cycle, and/or number of times in which operations 1501, 1502, and 1503 shown in FIG. 15 are performed are not limited to those shown in FIG. 15.

For example, an operation time of the deionization operation 1502 may be longer than that of the regeneration operation 1503.

In one or more embodiments, the water treatment apparatus 1 may perform the deionization operation 1501 for a first period of time and perform the regeneration operation 1502 for a second period of time. In this instance, the first period of time may be set longer than the second period of time. Also, the first period of time and the second period of time may be set by a user.

In one or more embodiments, the water treatment apparatus 1 may perform the post-treatment operation 1503, based on the deionization operation 1501 and the regeneration operation 1502 having been performed a predetermined number of times. In this instance, the predetermined number of times may be set by a user.

In a case where the predetermined number of times is set to a plurality of times, an operation cycle of the deionization operation 1501 and an operation cycle of the regeneration operation 1502 may be shorter than an operation cycle of the post-treatment operation 1503. For example, the water treatment apparatus 1 may perform the post-treatment operation 1503 once after performing each of the deionization operation 1501 and the regeneration operation 1502 n times (n is a natural number greater than or equal to 2).

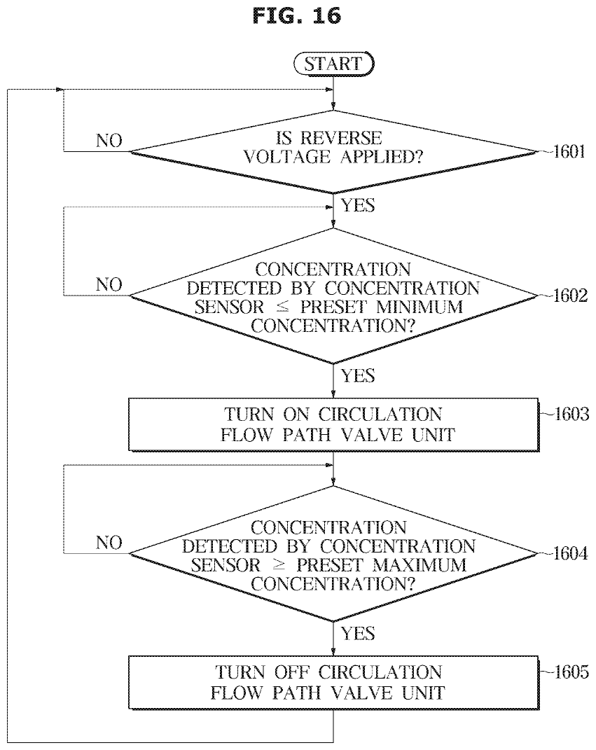

FIG. 16 is a flowchart illustrating a method for controlling a water treatment apparatus according to one or more embodiments.

Referring to FIG. 16, the water treatment apparatus 1 according to one or more embodiments may control the circulation flow path valve unit 31 to maintain a concentration of the electrolyte in the deionization module 100 within a preset range during the regeneration operation.

The controller 70 may determine whether a reverse voltage of the voltage applied in the deionization operation is applied between the first electrode 11ab and the second electrode 12ab of the deionization module 100 (1601).

The reverse voltage being applied between the first electrode 11ab and the second electrode 12ab may indicate that the deionization module 100 has started the regeneration operation.

When the reverse voltage of the voltage applied in the deionization operation is applied between the first electrode 11ab and the second electrode 12ab (Yes in operation 1601), the controller 70 may receive information about an electrolyte concentration in the first channel 11 detected by the concentration sensor 50.

As described above, a change in the electrolyte concentration in the first channel 11 may correspond to a change in the electrolyte concentration in the deionization module 100.

Accordingly, the controller 70 may determine whether the electrolyte concentration detected by the concentration sensor 50 is less than or equal to a preset minimum concentration (1602).

The preset minimum concentration may be set as an initial setting in a manufacturing process of the water treatment apparatus 1, and may be stored in the memory 72 of the water treatment apparatus 1.

In addition, information for setting the preset minimum concentration may be received from a user through the user interface 40 before, after, and during the desalination operation.

In a case where the electrolyte concentration detected by the concentration sensor 50 is less than or equal to the preset minimum concentration (Yes in operation 1602), the controller 70 may turn on the circulation flow path valve unit 31 (1603).

When the circulation flow path valve unit 31 is turned on by the controller 70, the electrolyte aqueous solution may flow from the storage tank 90 to the first channel 11 through the flow circulation path 26 connecting the storage tank 90 and the first channel 11, and may flow from the first channel 11 to the second channel 12 through the circulation flow path 27 connecting the first channel 11 and the second channel 12.

In addition, the electrolyte aqueous solution may flow from the second channel 12 to the storage tank 90 through the auxiliary flow path 28 connecting the second channel 12 and the storage tank 90.

That is, the controller 70 may turn on the circulation flow path valve unit 31, thereby forming an electrolyte aqueous solution circulation cycle of the storage tank 90→the first channel 11→the second channel 12→the storage tank 90.

In this instance, the ion exchange resin layer 17 may be regenerated while the regeneration operation is performed, and cations and anions in the electrolyte aqueous solution may bond with functional groups of the ion exchange resins 17a and 17b while regenerating the ion exchange resin layer 17.

Accordingly, when the regeneration operation is performed, the concentration of the electrolyte aqueous solution in the deionization module 100 may be equal to or lower than that of the electrolyte aqueous solution in the storage tank 90. In other words, the concentration of the electrolyte aqueous solution flowing from the second channel 12 to the storage tank 90 may be equal to or higher than that of the electrolyte aqueous solution flowing from the storage tank 90 to the first channel 11.

That is, after the controller 70 turns on the circulation flow path valve unit 31, the concentration of the electrolyte aqueous solution in the deionization module 100 may increase.

The controller 70 may determine whether the electrolyte concentration detected by the concentration sensor 50 is greater than or equal to a preset maximum concentration (1604).

The preset maximum concentration may be set as an initial setting in the manufacturing process of the water treatment apparatus 1, and may be stored in the memory 72 of the water treatment apparatus 1.

In addition, information for setting the preset maximum concentration may be received from a user through the user interface 40 before, after, and during the desalination operation.

In a case where the electrolyte concentration detected by the concentration sensor 50 is greater than or equal to the preset maximum concentration (Yes in operation 1604), the controller 70 may turn off the circulation flow path valve unit 31 (1605).

When the circulation flow path valve unit 31 is turned off by the controller 70, the electrolyte aqueous solution may be blocked from flowing from the storage tank 90 to the first channel 11 through the circulation flow path 26 connecting the storage tank 90 and the first channel 11, and may be blocked from flowing from the first channel 11 to the second channel 12 through the circulation flow path 27 connecting the first channel 11 and the second channel 12.

In addition, the flow of the electrolyte aqueous solution from the second channel 12 to the storage tank 90 through the auxiliary flow path 28 connecting the second channel 12 and the storage tank 90 may be blocked.

That is, the controller 70 may turn off the circulation flow path valve unit 31, thereby blocking the supply of the electrolyte from the storage tank 90 to the deionization module 100.

In a case where the regeneration operation is being performed after the electrolyte supply is blocked, cations and anions in the electrolyte aqueous solution may bond with the functional groups of the ion exchange resins 17a and 17b while regenerating the ion exchange resin layer 17, and the concentration of the electrolyte aqueous solution in the deionization module 100 may decrease.

Based on the water treatment apparatus 1 continuing the regeneration operation (i.e., based on the reverse voltage being applied to the deionization module 100), the controller 70 may detect the concentration of the electrolyte aqueous solution in the first channel 11 through the concentration sensor 50, and may repeat turning on/off of the circulation flow path valve unit 31 based on the detected concentration.

The water treatment apparatus 1 according to one or more embodiments may maintain the electrolyte concentration in the deionization module 100 within a preset range by turning on or off the circulation flow path valve unit 31.

According to an aspect of the disclosure, by supplying the electrolyte aqueous solution to the deionization module, a deionization performance of the deionization module in the deionization operation may increase, addition of separate chemicals for regeneration of the ion exchange resin layer is not required in the regeneration operation, and scale generation may be lower compared to a water treatment apparatus solely equipped with one of a CDI module or an EDI module.

That is, the water treatment apparatus 1 according to one or more embodiments may maintain the electrolyte concentration in the deionization module 100 within a preset range, thereby increasing regeneration efficiency of the electrodes and the ion exchange resin layer 17 in the deionization module 100 and reducing scale generation.

According to one or more embodiments of the disclosure, a water treatment apparatus may include: a first channel including a first current collector and a cation exchange membrane; a second channel including a second current collector and an anion exchange membrane; a third channel arranged between the first channel and the second channel and including an ion exchange resin layer; a storage tank configured to store an electrolyte aqueous solution supplied to at least one of the first channel or the second channel; a circulation flow path valve unit provided on a circulation flow path configured to connect the first channel, the second channel, and the storage tank; and a controller configured to control the circulation flow path valve unit to allow the electrolyte aqueous solution to circulate through the first channel, the second channel, and the storage tank, based on at least one of a deionization operation or a regeneration operation being performed in a desalination operation.

The circulation flow path valve unit may include a first circulation flow path valve configured to adjust a flow of the electrolyte aqueous solution supplied to the first channel, and a second circulation flow path valve configured to adjust a flow of the electrolyte aqueous solution supplied to the second channel, and the controller may be configured to control the first circulation flow path valve and the second circulation flow path valve to allow the electrolyte aqueous solution to be supplied to at least one of the first channel or the second channel.

The circulation flow path valve unit may further include a third circulation flow path valve configured to adjust a flow of the electrolyte aqueous solution supplied to the storage tank, and the controller may be configured to control the third circulation flow path valve to allow the electrolyte aqueous solution to be supplied to the storage tank from at least one of the first channel or the second channel.

The water treatment apparatus may further include a concentration sensor configured to detect a concentration of the electrolyte aqueous solution in the first channel, and the controller may be configured to turn on the first circulation flow path valve, the second circulation flow path valve, and the third circulation flow path valve, based on the concentration detected by the concentration sensor being less than or equal to a preset minimum concentration.

The controller may be configured to turn off the first circulation flow path valve, the second circulation flow path valve, and the third circulation flow path valve, based on the concentration detected by the concentration sensor being greater than or equal to a preset maximum concentration.

The ion exchange resin layer may be provided only in a portion of the third channel.

The ion exchange resin layer may include a weak base anion exchange resin or a weak acid cation exchange resin.

The weak base anion exchange resin may have trimethylamine (TMA) or dimethylethanolamine (DMEA) as a functional group.

The weak acid cation exchange resin may have a carboxyl group (—COOH) as a functional group.

The water treatment apparatus may further include a power supply device configured to apply a voltage to the first current collector and the second current collector during the deionization operation and the regeneration operation, and the controller may be configured to: in the deionization operation, apply a negative voltage between the first current collector and the second current collector to cause cations dissolved in water in the third channel to be adsorbed on the ion exchange resin or move to the first channel, and in the regeneration operation, apply a positive voltage between the first current collector and the second current collector to cause the cations adsorbed on the ion exchange resin to be desorbed and dissolved in the water in the third channel and cause cations in the first channel to move to the water in the third channel.

The controller may be configured to control the power supply device to allow a magnitude of a voltage applied between the first current collector and the second current collector to be less than a water dissociation generation voltage.

According to one or more embodiments of the disclosure, in a method for controlling a water treatment apparatus including a first channel, a second channel, a third channel arranged between the first channel and the second channel and including an ion exchange resin layer, and a storage tank configured to store an electrolyte aqueous solution supplied to at least one of the first channel or the second channel, the method may include: supplying the electrolyte aqueous solution to the first channel by controlling a first circulation flow path valve configured to adjust a flow of the electrolyte aqueous solution supplied to the first channel, based on at least one of a deionization operation or a regeneration operation being performed in a desalination operation; and supplying the electrolyte aqueous solution to the second channel by controlling a second circulation flow path valve configured to adjust a flow of the electrolyte aqueous solution supplied to the second channel.

The method may further include: supplying the electrolyte aqueous solution to the storage tank from at least one of the first channel or the second channel by controlling a third circulation flow path valve configured to adjust a flow of the electrolyte aqueous solution supplied to the storage tank.

The water treatment apparatus may further include a concentration sensor configured to detect a concentration of the electrolyte aqueous solution in the first channel, and the method may further include turning on the first circulation flow path valve, the second circulation flow path valve, and the third circulation flow path valve, based on the concentration detected by the concentration sensor being less than or equal to a preset minimum concentration.

The method may further include turning off the first circulation flow path valve, the second circulation flow path valve, and the third circulation flow path valve, based on the concentration detected by the concentration sensor being greater than or equal to a preset maximum concentration.

The ion exchange resin layer may be provided only in a portion of the third channel.

The ion exchange resin layer may include a weak base anion exchange resin or a weak acid cation exchange resin.

The weak base anion exchange resin may have trimethylamine (TMA) or dimethylethanolamine (DMEA) as a functional group.

The weak acid cation exchange resin may have a carboxyl group (—COOH) as a functional group.

The water treatment apparatus may further include a power supply device configured to apply a voltage to the first current collector and the second current collector during the deionization operation and the regeneration operation, and the method may further include: in the deionization operation, applying a negative voltage between the first current collector and the second current collector to cause cations dissolved in water in the third channel to be adsorbed on the ion exchange resin or move to the first channel, and in the regeneration operation, applying a positive voltage between the first current collector and the second current collector to cause the cations adsorbed on the ion exchange resin to be desorbed and dissolved in the water in the third channel and cause cations in the first channel to move to the water in the third channel.

A magnitude of the voltage applied between the first current collector and the second current collector may be less than a water dissociation generation voltage.

The disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

In addition, the computer-readable recording medium may be provided in the form of a non-transitory recording medium. Here, when a recording medium is referred to as “non-transitory”, it may be understood that the recording medium is tangible and does not include a signal (e.g., an electromagnetic wave), but rather that data is semi-permanently or temporarily stored in the recording medium. For example, a “non-transitory recording medium” may include a buffer in which data is temporarily stored.

The method according to the various embodiments disclosed herein may be provided in a computer program product. The computer program product may be traded between a seller and a buyer as a product. The computer program product may be distributed in the form of a machine-readable recording medium (e.g., compact disc read only memory (CD-ROM)), or may be distributed (e.g., download or upload) through an application store (e.g., Play Store™) online or directly between two user devices (e.g., smartphones). In the case of online distribution, at least a portion of the computer program product (e.g., downloadable app) may be stored at least semi-permanently or may be temporarily generated in a recording medium, such as a memory of a server of a manufacturer, a server of an application store, or a relay server.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

What is claimed is:

1. A water treatment apparatus comprising:
a first channel comprising a first current collector and a cation exchange membrane;
a second channel comprising a second current collector and an anion exchange membrane;
a third channel between the first channel and the second channel and comprising an ion exchange resin layer;
a storage tank configured to store an electrolyte aqueous solution supplied to at least one of the first channel or the second channel;
at least one circulation flow path valve provided on a circulation flow path configured to connect the first channel, the second channel, and the storage tank; and
a controller comprising a processor, the controller being configured to control the at least one circulation flow path valve to allow the electrolyte aqueous solution to circulate through the first channel, the second channel, and the storage tank, based on at least one of a deionization operation being performed in a desalination operation or a regeneration operation being performed in the desalination operation.

2. The water treatment apparatus of claim 1, wherein the at least one circulation flow path valve comprises:
a first circulation flow path valve configured to adjust a first flow of the electrolyte aqueous solution supplied to the first channel; and
a second circulation flow path valve configured to adjust a second flow of the electrolyte aqueous solution supplied to the second channel, and
wherein the controller is further configured to control the first circulation flow path valve and the second circulation flow path valve to allow the electrolyte aqueous solution to be supplied to at least one of the first channel or the second channel.

3. The water treatment apparatus of claim 2, wherein the at least one circulation flow path valve further comprises a third circulation flow path valve configured to adjust a third flow of the electrolyte aqueous solution supplied to the storage tank, and
wherein the controller is further configured to control the third circulation flow path valve to allow the electrolyte aqueous solution to be supplied to the storage tank from at least one of the first channel or the second channel.

4. The water treatment apparatus of claim 3, further comprising:
a concentration sensor configured to detect a concentration of the electrolyte aqueous solution in the first channel,
wherein the controller is further configured to turn on the first circulation flow path valve, the second circulation flow path valve, and the third circulation flow path valve, based on the concentration detected by the concentration sensor being less than or equal to a preset minimum concentration.

5. The water treatment apparatus of claim 4, wherein the controller is further configured to turn off the first circulation flow path valve, the second circulation flow path valve, and the third circulation flow path valve, based on the concentration detected by the concentration sensor being greater than or equal to a preset maximum concentration.

6. The water treatment apparatus of claim 1, wherein the ion exchange resin layer is provided only in a portion of the third channel.

7. The water treatment apparatus of claim 1, wherein the ion exchange resin layer comprises at least one of a weak base anion exchange resin or a weak acid cation exchange resin.

8. The water treatment apparatus of claim 7, wherein the ion exchange resin layer comprises the weak base anion exchange resin, and the weak base anion exchange resin comprises trimethylamine (TMA) or dimethylethanolamine (DMEA) as a functional group.

9. The water treatment apparatus of claim 7, wherein the ion exchange resin layer comprises the weak acid cation exchange resin, and the weak acid cation exchange resin comprises a carboxyl group (—COOH) as a functional group.

10. The water treatment apparatus of claim 1, further comprising:
a power supply device configured to apply a voltage to the first current collector and the second current collector during the deionization operation and the regeneration operation, and
wherein the controller is further configured to:
in the deionization operation, apply a negative voltage between the first current collector and the second current collector to cause cations dissolved in water in the third channel to be adsorbed on the ion exchange resin layer or move to the first channel, and
in the regeneration operation, apply a positive voltage between the first current collector and the second current collector to cause the cations adsorbed on the ion exchange resin layer to be desorbed and dissolved in the water in the third channel and cause the cations in the first channel to move to the water in the third channel.

11. The water treatment apparatus of claim 10, wherein the controller is further configured to control the power supply device to allow a magnitude of the voltage applied to the first current collector and the second current collector to be less than a water dissociation generation voltage.

12. The water treatment apparatus of claim 1, wherein the controller is further configured to control the at least one circulation flow path valve to allow the electrolyte aqueous solution to circulate through the first channel, the second channel, and the storage tank, based on a post-treatment operation being performed during the desalination operation.

13. A method for controlling a water treatment apparatus comprising a first channel, a second channel, a third channel between the first channel and the second channel and including an ion exchange resin layer, and a storage tank configured to store an electrolyte aqueous solution supplied to at least one of the first channel or the second channel, the method comprising:
supplying the electrolyte aqueous solution to the first channel by controlling a first circulation flow path valve configured to adjust a first flow of the electrolyte aqueous solution supplied to the first channel, based on at least one of a deionization operation or a regeneration operation being performed in a desalination operation; and
supplying the electrolyte aqueous solution to the second channel by controlling a second circulation flow path valve configured to adjust a second flow of the electrolyte aqueous solution supplied to the second channel.

14. The method of claim 13, further comprising:
supplying the electrolyte aqueous solution to the storage tank from at least one of the first channel or the second channel by controlling a third circulation flow path valve configured to adjust a third flow of the electrolyte aqueous solution supplied to the storage tank.

15. The method of claim 14, wherein the water treatment apparatus further comprises a concentration sensor configured to detect a concentration of the electrolyte aqueous solution in the first channel, and
wherein the method further comprises turning on the first circulation flow path valve, the second circulation flow path valve, and the third circulation flow path valve, based on the concentration detected by the concentration sensor being less than or equal to a preset minimum concentration.

16. The method of claim 15, further comprising:
turning off the first circulation flow path valve, the second circulation flow path valve, and the third circulation flow path valve, based on the concentration detected by the concentration sensor being greater than or equal to a preset maximum concentration.

17. The method of claim 13, wherein the ion exchange resin layer is provided only in a portion of the third channel.

18. The method of claim 13, wherein the ion exchange resin layer comprises at least one of a weak base anion exchange resin or a weak acid cation exchange resin.

19. The method of claim 18, wherein the ion exchange resin layer comprises the weak base anion exchange resin, and the weak base anion exchange resin comprises trimethylamine (TMA) or dimethylethanolamine (DMEA) as a functional group.

20. The method of claim 18, wherein the ion exchange resin layer comprises the weak acid cation exchange resin, and the weak acid cation exchange resin comprises a carboxyl group (—COOH) as a functional group.
